(19) United States
(12) Patent Application Publication
(10) Pub. No.: US 2025/0365594 A1
(43) Pub. Date: Nov. 27, 2025

(54) CONFIGURING LAYER 1 AND LAYER 2 MOBILITY BASED ON MEASUREMENT REPORTS WHILE IN A CONNECTED STATE

(71) Applicant: Telefonaktiebolaget LM Ericsson (PUBL), Stockholm (SE)

(72) Inventors: Icaro Leonardo Da Silva, SOLNA (SE); Ioanna Pappa, STOCKHOLM (SE); Liwei Qiu, TÄBY (SE); Antonino Orsino, KIRKKONUMMI (FI)

(21) Appl. No.: 18/873,932

(22) PCT Filed: Jun. 14, 2023
(86) PCT No.: PCT/IB2023/056146

§ 371 Date: Dec. 11, 2024

Related U.S. Application Data
(60) Provisional application No. 63/352,278, filed on Jun. 15, 2022.

(51) Int. Cl. H04W 24/10; H04B 7/06; H04B 17/318

(52) U.S. Cl. CPC H04W 24/10; H04B 7/0626; H04B 17/328

(57) ABSTRACT

A method (1300) by a user equipment, UE (402, 502, 602, 800), in a connected state is provided for configuring Layer 1/Layer 2, L1/L2, based inter-cell mobility. The method includes transmitting (1302) a Measurement Report comprising one or more measurements associated with one or more cells. The UE receives (1304) a Radio Resource Control, RRC, Reconfiguration message comprising at least one configuration of a L1/L2 based inter-cell mobility candidate cell. The UE transmits (1306) an RRC Reconfiguration Complete message.

### TECHNICAL FIELD

The present disclosure relates, in general, to wireless communications and, more particularly, systems and methods for configuring Layer 1 (L1)/Layer 2 (L2) mobility based on measurements reports while in a connected state.

### BACKGROUND

According to 3GPP TS 38.473 (§ 8.3.4), a gNodeB-Central Unit (gNB-CU) may initiate a User Equipment (UE) Context Modification procedure to modify the established UE Context, e.g., establishing, modifying and releasing radio resources. FIG. 1 illustrates successful operation of a UE Context Modification Procedure.

As depicted in FIG. 1, the UE CONTEXT MODIFICATION REQUEST message is initiated by the gNB-CU. Upon reception of the UE CONTEXT MODIFICATION REQUEST message, the gNodeB-Distributed Unit (gNB-DU) shall perform the modifications, and if successful reports the update in the UE CONTEXT MODIFICATION RESPONSE message.

In Release 18, 3GPP has agreed on a Work Item (WI) on Further New Radio (NR) mobility enhancements, in particular, in a technical area entitled L1/L2 based inter-cell mobility. See, WI description (WID) in RP-213565, (https://www.3gpp.org/ftp/TSG_RAN/TSG_RAN/TSGR 94e/-Docs//RP-213565.zip, last visited Jun. 15, 2022).

According to the WID, when the UE moves from the coverage area of one cell to another cell, at some point a serving cell change needs to be performed. Currently serving cell change is triggered by Layer 3 (L3) measurements and is done by Radio Resource Control (RRC) signalling triggered Reconfiguration with Synchronisation for change of Primary Cell (PCell) and Primary Secondary Cell (PSCell), as well as release add for Secondary Cells (SCells) when applicable. All cases involve complete L2 and L1 resets, leading to longer latency, larger overhead and longer interruption time than beam switch mobility. The goal of L1/L2 mobility enhancements is to enable a serving cell to change via L1/L2 signalling, in order to reduce the latency, overhead and interruption time.

The goal is to specify mechanism and procedures of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including Special Cell (SpCell) and SCell) for the potential applicable scenarios based on L1/L2 signalling [RAN2, RAN1]
L1 enhancements for inter-cell beam management, including L1 measurement and reporting, and beam indication [RAN1, RAN2]
   Note 1: Early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]
   Note 2: Frequency Range 2 (FR2) specific enhancements are not precluded, if any.
   Note 3: The procedure of L1/L2 based inter-cell mobility are applicable to the following scenarios:
   Standalone, Carrier Aggregation (CA), and New Radio-Dual Connectivity (NR-DC) case with serving cell change within one Configured Grant (CG)
   Intra-DU case and intra-CU inter-DU case (applicable for Standalone and CA: no new RAN interfaces are expected)
   Both Frequency Range 1 (FR1) and FR2
   Both intra-frequency and inter-frequency
   Source and target cells may be synchronized or non-synchronized

There currently exist certain challenge(s). For example, as discussed above, among the goals of L1/L2 based inter-cell mobility for mobility latency reduction is the CU-DU interface signaling to support L1/L2 mobility, if needed. The following scenarios are also mentioned: intra-DU case and intra-CU inter-DU case (applicable for Standalone and CA).

For a UE in RRC_CONNECTED, it is not clear which criteria would be used by the network to determine when it should configure the UE with L1/L2 mobility candidate(s). It is also not clear how, in a Radio Access Network (RAN) split architecture, the CU and DU interact in order to configure the UE with L1/L2 mobility candidate(s) and other necessary configuration to support L1/L2 mobility, such as the configuration of Channel State Information (CSI) measurement (e.g., CSI-MeasConfig). Another issue occurs when the UE has a limitation in terms of the maximum number of L1/L2 inter-cell mobility candidates (e.g., K1) that it may be configured with, and the DU to which the UE is connected (serving DU) has the possibility to configure more than K1 candidates. In this case, it is not clear how to determine which L1/L2 inter-cell mobility candidate cells with which to configure the UE.

### SUMMARY

Certain aspects of the disclosure and their embodiments may provide solutions to these or other challenges. For example, methods and systems are for configuring L1/L2 based inter-cell mobility for a UE in RRC_CONNECTED state. According to certain embodiments, the decision to configure one or more L1/L2 based inter-cell mobility candidates is based on Measurement Report(s) that are reported by the UE and received at the CU via the DU.

According to certain embodiments, a method by a UE includes in a connected state for configuring L1/L2 based inter-cell mobility includes transmitting a Measurement Report comprising one or more measurements associated with one or more cells. The UE receives a RRC Reconfiguration message comprising at least one configuration of a L1/L2 based inter-cell mobility candidate cell. The UE transmits an RRC Reconfiguration Complete message.

According to certain embodiments, a UE in a connected state for configuring L1/L2 based inter-cell mobility is adapted to transmit a Measurement Report comprising one or more measurements associated with one or more cells. The UE is adapted to receive a RRC Reconfiguration message comprising at least one configuration of a L1/L2 based inter-cell mobility candidate cell. The UE is adapted to transmit an RRC Reconfiguration Complete message.

According to certain embodiments, a method by a CU for configuring L1/L2 based inter-cell mobility for a UE in a connected state includes transmitting, to a candidate DU, at least one request for the candidate DU to configure the UE with L1/L2 based inter-cell mobility. The at least one request indicates at least one L1/L2 based inter-cell mobility candidate cell. The CU receives, from the candidate DU, at least one configuration of the L1/L2 based inter-cell mobility candidate cell. The CU transmits, to the candidate DU, a RRC Reconfiguration to be transmitted to the UE, and the RRC Reconfiguration includes the at least one configuration of the L1/L2 based inter-cell mobility candidate cell. The CU receives, from the candidate DU, an RRC Reconfiguration Complete from the UE.

According to certain embodiments, a CU for configuring L1/L2 based inter-cell mobility for a UE in a connected state is adapted to transmit, to a candidate DU, at least one request for the candidate DU to configure the UE with L1/L2 based inter-cell mobility. The at least one request indicates at least one L1/L2 based inter-cell mobility candidate cell. The CU is adapted to receive, from the candidate DU, at least one configuration of the L1/L2 based inter-cell mobility candidate cell. The CU is adapted to transmit, to the candidate DU, a RRC Reconfiguration to be transmitted to the UE, and the RRC Reconfiguration includes the at least one configuration of the L1/L2 based inter-cell mobility candidate cell. The CU is adapted to receive, from the candidate DU, an RRC Reconfiguration Complete from the UE.

According to certain embodiments, a method by a candidate DU for configuring L1/L2 based inter-cell mobility for a UE in a connected state includes receiving, from a CU, at least one request for the candidate DU to configure the UE with L1/L2 based inter-cell mobility. The at least one request indicates at least one L1/L2 based inter-cell mobility candidate cell. The candidate DU transmits, to the CU, at least one configuration of the L1/L2 based inter-cell mobility candidate cell. The candidate DU receives, from the CU, a RRC Reconfiguration. The RRC Reconfiguration comprises the at least one configuration of the L1/L2 based inter-cell mobility candidate cell. The candidate DU receives an RRC Reconfiguration Complete from the UE and transmits, to the CU, the RRC Reconfiguration Complete from the UE.

According to certain embodiments, a target DU for configuring L1/L2 based inter-cell mobility for a UE in a connected state is adapted to receive, from a CU, at least one request for the candidate DU to configure the UE with L1/L2 based inter-cell mobility. The at least one request indicates at least one L1/L2 based inter-cell mobility candidate cell. The candidate DU is adapted to transmit, to the CU, at least one configuration of the L1/L2 based inter-cell mobility candidate cell. The candidate DU is adapted to receive, from the CU, a RRC Reconfiguration. The RRC Reconfiguration comprises the at least one configuration of the L1/L2 based inter-cell mobility candidate cell. The candidate DU is adapted to receive an RRC Reconfiguration Complete from the UE and transmit, to the CU, the RRC Reconfiguration Complete from the UE.

Certain embodiments may provide one or more of the following technical advantage(s). For example, certain embodiments may provide a technical advantage of defining CU-DU interface signaling to support the configuration of L1/L2 mobility that is more educated since it is based on Measurement Reports when the UE is in RRC_CONNECTED. A clear benefit is when the UE has a limitation in terms of the maximum number of L1/L2 inter-cell mobility candidates (e.g., K1) and the DU the UE is connected to have the possibility to configure more than K1 candidates, so that the content of the Measurement Report(s) indicate which are the best candidates. For example, the Measurement Reports may indicate the ones with strongest/highest Reference Signal Received Power (RSRP) and/or Reference Signal Received Quality (RSRQ) and/or Signal Interference to Noise Ratio (SINR). As such, a technical advantage may be that the configuration of L1/L2 inter-cell mobility candidates will not exceed UE capabilities, according to certain embodiments.

As another example, certain embodiments may provide a technical advantage of enabling a UE connected to a CU and DU, in RRC_CONNECTED, to receive an RRC Reconfiguration, prepared by both the CU and the DU in a RAN (e.g. NG-RAN), which includes the necessary configuration for performing L1/L2 based inter-cell mobility. For example, according to certain embodiments, the configuration(s) of L1/L2 inter-cell mobility candidates are generated by the DU, which is the same DU the UE is connected to, and the same DU which will re-configure the CSI measurement configuration necessary to support L1/L2 inter-cell mobility such as, for example, for re-configuring the UE to perform CSI measurements on one or more L1/L2 inter-cell mobility candidates and report these measurements, so the network (e.g., the DU) can make educated mobility decisions for L1/L2 inter-cell mobility. Thus, in the RAN split architecture, a technical advantage may be that certain embodiments make it clear how the CU and DU interact in order to configure the UE with L1/L2 mobility candidate(s) and other necessary configuration to support L1/L2 mobility, such as the configuration of CSI measurement (e.g. CSI-MeasConfig).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates successful operation of a UE Context Modification Procedure;

FIG. 2 illustrates an example split architecture with both a NG-Radio Access Network (NG-RAN) and 5^{th} Generation Core (5GC), according to certain embodiments;

FIG. 3 illustrates a possible deployment scenario of a logical gNB/en-gNB, according to certain embodiments;

FIG. 4 illustrates an example architecture for separation of gNB-CU-CP and gNB-CU-UP, according to certain embodiments;

FIG. 5 illustrates an example signaling flow diagram for configuring a UE 402 in RRC_CONNECTED for L1/L2 mobility, according to certain embodiments;

FIG. 6 illustrates example signaling flow for a UE, CU, and DU, according to certain embodiments;

FIG. 7 illustrates another example signaling between a UE, DU, and CU where a single procedure may be triggered to configure multiple L1/L2 inter-cell mobility candidates, according to certain embodiments;

FIG. 8 illustrates an example communication system, according to certain embodiments;

FIG. 9 illustrates an example UE, according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method by a UE in a connected state for configuring L1/L2 based inter-cell mobility, according to certain embodiments;

FIG. 15 illustrates a method by a CU, for configuring L1/L2 based inter-cell mobility for a UE in a connected state, according to certain embodiments; and

FIG. 16 illustrates a method by a candidate DU for configuring L1/L2 based inter-cell mobility for a UE in a connected state, according to certain embodiments.

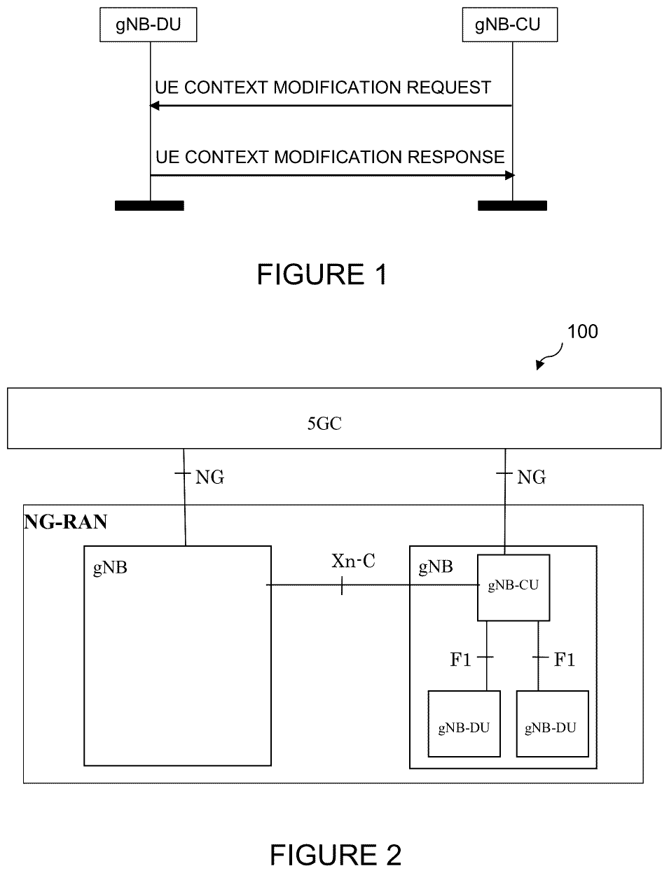

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE, or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

FIG. 2 illustrates an example split architecture 100 with both a NG-Radio Access Network (NG-RAN) and 5^{th} Generation Core (5GC), according to certain embodiments. As depicted the NG-RAN is split in a CU 202 and a DU 204 via a F1 interface. In this particular example, the RAN is a Next-Generation RAN (NG-RAN), which may be referred as the 5G RAN, however, the method is applicable to any RAN such as a 6G RAN architecture.

As depicted, the RAN (e.g., NG-RAN) consists of a set of RAN nodes (e.g., gNBs) connected to a Core Network (e.g., a 5GC) through a RAN/CN interface (e.g., NG interface). In the case of NG-RAN, that may comprise one or more Next Generation-eNBs (ng-eNBs), which may consist of an ng-eNB-CU and one or more ng-eNB-DU(s). A gNB may consist of a gNB-CU and one or more gNB-DU(s). A gNB-CU and a gNB-DU is connected via F1 interface. A gNB-DU may be connected to multiple gNB-CUs by appropriate implementation. The methods and systems presented herein are applicable to the NG-RAN as an example; however, the method is also applicable to any RAN architecture, such as a 6G RAN.

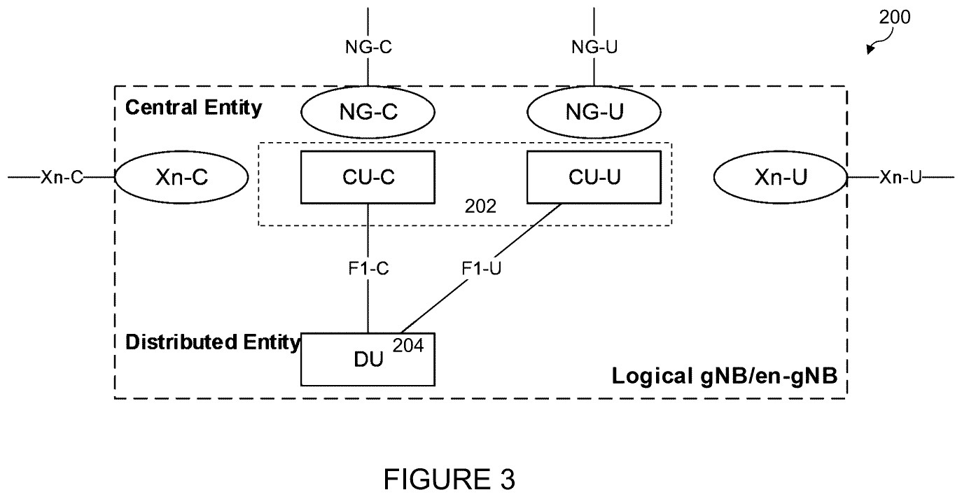

NG, Xn and F1 are logical interfaces. And, in case of the NG-RAN, the NG and Xn-C interfaces for a gNB consisting of a gNB-CU and gNB-DUs, terminate in the gNB-CU. For E-Evolved-UMTS Terrestrial Radio Access Network (UTRAN) New Radio-Dual Connectivity (EN-DC), the S1-U and X2-C interfaces for a gNB consisting of a gNB-CU and gNB-DUS, terminate in the gNB-CU. The gNB-CU and connected gNB-DUs are only visible to other gNBs and the 5GC as a gNB. FIG. 3 illustrates a possible deployment scenario 200 of a logical gNB/en-gNB, according to certain embodiments. The Protocol terminations of the NG and Xn interfaces are depicted as ellipses and, the terms “Central Entity” and “Distributed Entity” shown below refer to physical network nodes.

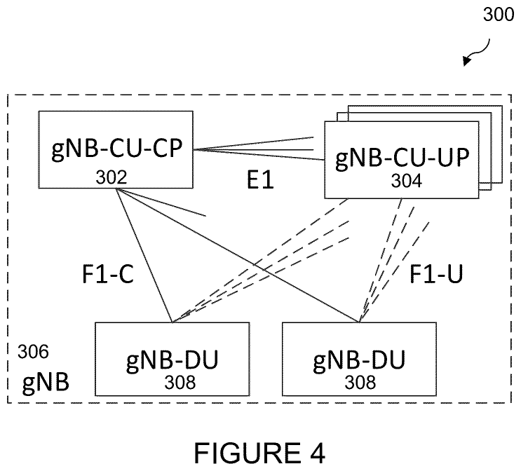

FIG. 4 illustrates an example architecture 300 for separation of gNB-CU-CP 302 and gNB-CU-UP 304 in a gNB 306, according to certain embodiments. According to various embodiments, it is recognized that one or more of the following may apply:
A gNB may consist of a gNB-CU-CP 302, multiple gNB-CU-Ups 304 and multiple gNB-DUs 308;
The gNB-CU-CP 302 may be connected to the gNB-DU 308 through the F1-C interface;
The gNB-CU-UP 304 may be connected to the gNB-DU 308 through the F1-U interface;
The gNB-CU-UP 304 may be connected to the gNB-CU-CP 302 through the E1 interface;
One gNB-DU 308 may be connected to only one gNB-CU-CP 302;
One gNB-CU-UP 304 may be connected to only one gNB-CU-CP 302;
One gNB-DU 308 may be connected to multiple gNB-CU-UPs 304 under the control of the same gNB-CU-CP 302;
One gNB-CU-UP 304 may be connected to multiple gNB-DUs 308 under the control of the same gNB-CU-CP 302;
   Thus, when the method refers to the CU the method comprises the action(s) being performed by any entities comprised within the CU (e.g., CU-CP, gNB-CU-CP.

The text herein refers to the term “L1/L2 based inter-cell mobility” as used in the Work Item Description in 3GPP; however, it is recognized that the text herein interchangeably also uses the terms L1/L2 mobility, L1-mobility, L1 based mobility, L1/L2-centric inter-cell mobility, or L1/L2 inter-cell mobility. The basic principle is that the UE receives a lower layer signaling from the network indicating to the UE a change of its serving cell (e.g., change of PCell, from a source to a target PCell), wherein a lower layer signaling is a message/signaling of a lower layer protocol. A lower layer protocol refers to a lower layer protocol in the air interface protocol stack compared to RRC protocol (e.g., Medium Access Control (MAC)) is considered a lower layer protocol as it is “below” RRC in the air interface protocol stack and, in this case, a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility; in addition, it may also increase the mobility robustness as the network may respond to faster changes in the channel conditions. Another relevant aspect in L1/L2 inter-cell mobility is that in multi-beam scenario, a cell can be associated to multiple SSBs, and during a half-frame, different SSBs may be transmitted in different spatial directions (i.e., using different beams spanning the coverage area of a cell). Similar reasoning may be applicable to Channel State Information-Reference Signal (CSI-RS) resources, which may also be transmitted in different spatial directions. Hence, in L1/L2 inter-cell mobility, the reception of a lower layer signaling indicates the UE to change from one beam in the serving cell to another beam in a neighbour cell (which is a configured candidate cell) and, by that, changing serving cell.

The text herein refers to the term “L1/L2 inter-cell mobility candidate cell” to refer to a cell the UE is configured with when configured with L1/L2 inter-cell mobility. That is a cell the UE can move to in a L1/L2 inter-cell mobility procedure, upon reception of a lower layer signaling. These cells may also be called candidate cells, candidates, mobility candidates, non-serving cells, additional cells, etc.

The text herein refers to configuration(s) generated by the DU, encapsulated in an RRC Reconfiguration message, that the UE receives when being configured with L1/L2 inter-cell mobility while in RRC_CONNECTED, after having transmitted a Measurement Report. The configuration(s) comprise one or more of:
At least one CSI measurement configuration;
   The one CSI measurement configuration comprises configuration/re-configuration of CSI reports and/or measurement resources and/or triggers, associated to one or more L1/L2 inter-cell mobility candidates. It re-configures/configures the UE to measure signal(s), such as Synchronization Signal Block (SSBs) and/or CSI-RS resources of a candidate for L1/L2 inter-cell mobility. In an example scenario, which is the UE already operating in RRC_CONNECTED receiving the at least one CSI measurement configuration, the UE may already have a CSI measurement configuration stored, so that the received at least one CSI measurement configuration comprises a reconfiguration, which is encoded in RRC as a delta signaling: parameters, fields, Information Elements (IEs) and configurations(s) provided are only the new ones to be applied, such as the ones related to measurements of the L1/L2 inter-cell mobility candidates (e.g., Synchronization Signaling Block (SSB) indexes for the candidates), while stored ones (e.g., which have need code M defined) remain stored and the UE continues to operate according to them.
   The measurement resource(s) configured/re-configured (e.g., added, by the network and to be measured by the UE) comprise one of more of: i) indications of at least one frequency (e.g., indicated by an absolute or relative frequency offset, like an ARFCN) of a signal of the L1/L2 inter-cell mobility candidate (e.g., SSB and/or CSI-RS, TRS) so the UE is able to search for and find the signal and/or ii) a cell identifier or identity (e.g., Physical Cell Identity (PCI)) and/or iii) one or more signal index(es) (e.g., SSB index(es) and/or CSI-RS resource index(es)) and/or iv) a cell index encoded in fewer bits than the cell identifier, and mapped to it.
   The at least one CSI measurement configuration is used to re-configure/configure CSI-RS belonging to the candidate cell (which may, for example, be a serving cell) in which CSI-MeasConfig is included. CSI reports to be transmitted on uplink control channel(s) (such as Physical Uplink Control Channel (PUCCH)) on the serving cell in which CSI-MeasConfig is included for CSI measurements on L1/L2 inter-cell mobility candidate cells, and CSI reports on Physical Uplink Shared Channel (PUSCH) triggered by DCI received on the serving cell in which CSI-MeasConfig is included, but for measurements on L1/L2 inter-cell mobility candidates.
A first cell group configuration associated to the current PCell the UE is operating in RRC_CONNECTED;
   The first cell group configuration comprises a re-configuration of the current PCell, which is the cell the UE is already configured to operate in RRC_CONNECTED, and the configuration of one or more SCell(s) associated to that first cell group.
   The first cell group configuration corresponds to the Master Cell Group (MCG) and is provided to the UE in the IE CellGroupConfig as defined in 3GPP TS 38.331.
   The configuration of the current PCell, within the first cell group configuration is provided to the UE in a parameter spCellConfig of IE SpCellConfig.
   If the at least one CSI measurement configuration for L1/L2 inter-cell mobility is not within a CellGroupConfig, the UE may receive the at least one CSI measurement configuration in a message not included in the first cell group configuration, for the operation with the current PCell/SpCell.
At least one configuration of a L1/L2 based inter-cell mobility candidate cell;
   The at least one of a L1/L2 based inter-cell mobility candidate cell comprises the configuration which the UE needs to operate accordingly when it performs (executes) L1/L2 inter-cell mobility to that L1/L2 based inter-cell mobility candidate cell, upon reception of the lower layer signaling indicating a L1/L2 based inter-cell mobility to that L1/L2 based inter-cell mobility candidate cell (which becomes the target cell and the current (new) PCell, or an SCell in a serving frequency).
   In the case the UE is configured with multiple candidates, the DU generates and sends to the CU multiple configuration(s) (e.g., each per L1/L2 based inter-cell mobility candidate cell).
   The configuration of a L1/L2 based inter-cell mobility candidate cell comprises parameters of a serving cell (or multiple serving cells), comprising one or more of the groups of parameters within the IE SpCellConfig (or the IE SCellConfig in the case of a Secondary Cell), such as:
      A cell index (e.g., encoding fewer bits than the cell identifier of the L1/L2 inter-cell mobility candidate cell). That may be a field ‘servCellIndex’ or ‘candidateCellIndex’ of IE ServCellIndex or IE CandidateCellIndex. After this being configured, the index may be later referred, for example: i) in the lower layer signaling to indicate to the UE that this is the L1/L2 inter-cell mobility candidate cell the UE needs to move to in the L1/L2 inter-cell mobility procedure; and/or ii) in an RRC message indicating some operation in that particular candidate cell.
      A cell configuration for the UE corresponding to the configuration of a L1/L2 based inter-cell mobility candidate cell, called a dedicated configuration as parameters are possibly adjusted for that specific UE, according to the UE capabilities/radio capabilities. The configuration may comprise parameters defined in the IE ServingCellConfig such as the frequency configuration for downlink and uplink (including Bandwidth parts), L1 control channels (such as PDCCH, CORESET(s)), and PUCCH) and L1 data channels (such as PDSCH and PUSCH) and further parameters as defined in the IE ServingCellConfig defined in 3GPP TS 38.331.
      A cell configuration called common cell configuration, also called cell-specific configuration, corresponds to the configuration of a L1/L2 based inter-cell mobility candidate cell in the IE ServingCellConfigCommon. That may be provided within the IE ReconfigurationWithSync or separately. This configuration contains, for example, the random access configuration for the UE to access the target candidate, if necessary.
      Radio Link Failure configuration(s) such as values for timer T310, counter N310, counter N311, and/or timer N311.
      At least one UE identifier to identify the UE in the L1/L2 based inter-cell mobility candidate cell such as, for example, a Cell Radio Network Temporary Identifier (C-RNTI).
   In the case the UE is configured with multiple L1/L2 inter-cell mobility candidate cells, the DU generates and sends to the CU, multiple sets of parameters of a serving cell, comprising one or more of the groups of parameters within multiple IE SpCellConfig(s). For example, the UE may receive a list of IEs SpCellConfig(s), one for each L1/L2 inter-cell mobility candidate.
   The configuration of a L1/L2 based inter-cell mobility candidate cell may be the SpCell configuration (e.g., PCell configuration) provided as part of a cell group configuration, which may further comprise one or more SCell configuration(s) and further cell group-specific configurations (cell group identity, physical layer configuration for the cell group, MAC layer configuration for the cell group, simultaneous TCI state configurations for the cell group, etc.).
      In this case, the UE is configured with a Cell Group configuration per candidate. Thus, one alternative is the UE to receive one configuration per Cell Group candidate, wherein the configuration of a L1/L2 based inter-cell mobility candidate cell is the SpCell candidate configuration within that group. Then, the lower layer signaling indicates the UE to change to a configured Cell Group candidate (e.g., applying the Cell Group configuration for that candidate (e.g., from a MCG configuration A to an MCG configuration B)).
   In the case the UE is configured with multiple candidates, the DU generates and sends to the CU, multiple cell group configuration(s), each associated to each L1/L2 inter-cell mobility candidates (e.g., a list of CellGroupConfig IEs).
   The L1/L2 inter-cell mobility candidate may be in the same frequency as the current PCell or in a different frequency.
   The L1/L2 inter-cell mobility candidate may be an SCell candidate.

According to certain embodiments disclosed herein, methods and systems are provided by a UE, a DU of a RAN node (e.g. a gNB-DU 308) and a CU of a RAN node (e.g. a gNB-CU 302-304) in a RAN (e.g., NG-RAN) for configuring L1/L2 based inter-cell mobility for a UE in RRC_CONNECTED state. According to certain embodiments, the decision to configure one or more L1/L2 based inter-cell mobility candidates is based on Measurement Report(s) that are reported by the UE and received at the CU via the DU.

According to certain embodiments, an example is one in which the UE is connected to a source DU (serving DU) and a CU. Upon receiving Measurement Report(s) via, for example, RRC, the source CU configures the UE with one or more L1/L2 inter-cell mobility candidates. Then, the source CU requests the source DU to configure one or more L1/L2 inter-cell mobility candidates i.e. the source DU is requested to also operate as a DU with L1/L2 inter-cell mobility candidate cells.

In a particular embodiment, the source CU determines which cells to request the DU, and the DU generates the configuration(s) for the accepted cells, to be provided to the CU, and to the UE.

In another particular embodiment, the source DU determines which cells to configure as L1/L2 inter-cell mobility candidates upon reception of the message from the CU including one or more measurements or the whole Measurement Report, and the DU generates the configuration(s) for the accepted cells, to be provided to the CU, and to the UE.

In a particular embodiment, the UE may be configured with a maximum number of L1/L2 inter-cell mobility candidates (e.g. K1) which is lower than the number of cells for L1/L2 inter-cell mobility in a DU to which the UE is connected.

Some examples of how the signaling could be implemented in RRC for the configuration of a L1/L2 based inter-cell mobility candidate cell, according to various embodiments, are provided below. These models are described as RRC models for L1/L2 based inter-cell mobility.

For example, an RRC model including example signaling for RRCReconfiguration per additional cell may be as follows:

RRCReconfiguration-IE ::= SEQUENCE (

| | |
|---|---|
| radioBearerConfig | RadioBearerConfig |
| masterCellGroup | OCTET STRING (CONTAINING CellGroupConfig) |
| measConfig | MeasConfig |

[...]
}
...
RRCReconfiguration-IE ::= SEQUENCE (

| | |
|---|---|
| radioBearerConfig | RadioBearerConfig |
| masterCellGroup | OCTET STRING (CONTAINING CellGroupConfig) |
| measConfig | MeasConfig |

[...]
}

In this scenario, the UE receives multiple (a list of) RRC messages (i.e., RRCReconfiguration message) within a single RRCReconfiguration message. Each RRCReconfiguration message identify a configuration of a L1/L2 based inter-cell mobility candidate cell that is stored by the UE and is applied/used/activated when receiving the lower layer signaling for L1/L2 inter-cell mobility. This model enables the full flexibility, as in L3 reconfigurations, for the target node to modify/release/keep any parameter/field in the RRCReconfiguration message such as measurement configuration, bearers, etc.

As another example, an RRC model including example signaling for CellGroupConfig per additional cells (PCell frequency) may be as follows:

RRCReconfiguration-IE ::= SEQUENCE (

| | |
|---|---|
| radioBearerConfig | RadioBearerConfig |
| masterCellGroup | OCTET STRING (CONTAINING CellGroupConfig) |
| measConfig | MeasConfig |
| addMCG-AddModList | SEQUENCE (SIZE (1...K)) OF ADD-MCG-ADDmod |

[...]
}

With this model the UE receives, within an RRCReconfiguration message, a list of CellGroupConfig IEs and each one of them identify a configuration of a L1/L2 based inter-cell mobility candidate cell. Each CellGroupConfig IE is stored at the UE and is applied/used/activated when receiving the lower layer signaling for L1/L2 inter-cell mobility. This model allows the target node to modify/release/keep any parameter/field that is part of a CellGroupConfig IE while the rest of the RRCReconfiguration message (that is where the CellGroupConfig IE is received by the UE) remain unchanged. This means that, for example, measurement configuration, bearers, and security remain the same and are not changed by the target node.

As another example, an RRC model including example signaling for K SpCellConfig(s) per cell (PCell frequency) may be as follows:

| | |
|---|---|
| CellGroupConfig ::= | SEQUENCE ( |
| cellGroupId | CellGroupId, |
| rlc-BearerToAddModList | SEQUENCE (SIZE(1..maxLC-ID)) OF |
| | RLC- BearerConfig |
| rlc-BearerToReleaseList | SEQUENCE (SIZE(1..maxLC-ID)) OF |
| | LogicalChannelIdentity |
| mac-CellGroupConfig | MAC-CellGroupConfig |
| physicalCellGroupConfig | PhysicalCellGroupConfig |
| spCellConfig | SpCellConfig |
| spCellToAddModList | SEQUENCE (SIZE (1..K)) OF |
| | SpCellConfig |
| sCellToAddModList | SEQUENCE (SIZE (1..maxNrofScells) |
| | OF SCellConfig |

[...]
}

With this model, the UE receives “K” SpCellConfig per cell as a configuration of a L1/L2 based inter-cell mobility candidate cell. This solution provides only minimum flexibility for the target node since only cell-specific parameters (e.g., bandwidth parts, downlink, and uplink configurations) can be modified/released/kept.

As another example, an RRC model including example signaling for K PCI(s) in the same PCell (e.g., SpCellConfig) may be as follows:

| TCI-State ::= | SEQUENCE ( |
|---|---|
| tci-StateId | TCI-StateId, |
| qcl-Type1 | QCL-Info, |
| [...] | |
| } | |
| QCL-Info ::= | SEQUENCE ( |
| [...] | |
| referenceSignal | CHOICE { |
| csi-rs | NZP-CSI-RS-ResourceId, |
| ssb | SSB-Index, |
| [...] | |
| } | |
| cellIndexReferenceSignal | ServeCellIndex |

[...]
}

With this model, the UE receives “K” ServingCellConfigCommon per cell (option d) as a configuration of a L1/L2 based inter-cell mobility candidate cell. This solution provides only minimum flexibility for the target node since only cell-specific parameters (e.g., bandwidth parts, downlink, and uplink configurations) can be modified/released/kept.

As another example, an RRC model including example signaling for K SpCellConfig/ServingCellConfigCommon per cell may be as follows:

| | |
|---|---|
| CellGroupConfig ::= | SEQUENCE { |

[_] // omitted for simplicity

| | |
|---|---|
| spCellConfig | SpCellConfig |
| addSpCellToAddModList | SEQUENCE (SIZE (1...K) OF |
| | AddSpCellConfig |

[..]
}

| | |
|---|---|
| AddSpCell Config ::= | SEQUENCE { |
| additionalSpCellIndex | ServCellIndex |
| additionalSpCellConfig | SpCellConfig, |
| additionalSpCellCommon | ServingCellconfigCommon |

}

With this model, the UE receives “K” ServingCellConfigCommon per cell as a configuration of a L1/L2 based inter-cell mobility candidate cell. This solution provides only minimum flexibility for the target node since only cell-specific parameters (e.g., bandwidth parts, downlink, and uplink configurations) can be modified/released/kept.

As another example, an RRC model including example signaling for K ServingCellConfigCommon(s) one per cell may be as follows:

| CellGroupConfig ::= | SEQUENCE { |
|---|---|
| [_] // omitted for simplicity | |
| spCellConfig | SpCellConfig |
| addSpCellToAddModList | SEQUENCE (SIZE (1...K) OF |
| | AddSpCellConfig |
| [..] | |
| } | |
| AddSpCell Config ::= | SEQUENCE { |
| additionalSpCellIndex | ServCellIndex |
| additionalSpCellCommon | ServingCellconfigCommon |

}

With this model multiple PCIs are configured for the same TCI state configuration where each PCI identify a configuration of a L1/L2 based inter-cell mobility candidate cell. This is approach that provide no flexibility at all since all the parameters/fields used for configuring a configuration of a L1/L2 based inter-cell mobility candidate cell are fixed and only a change of PCI, scrambling Id, and C-RNTI is allowed to the target node.

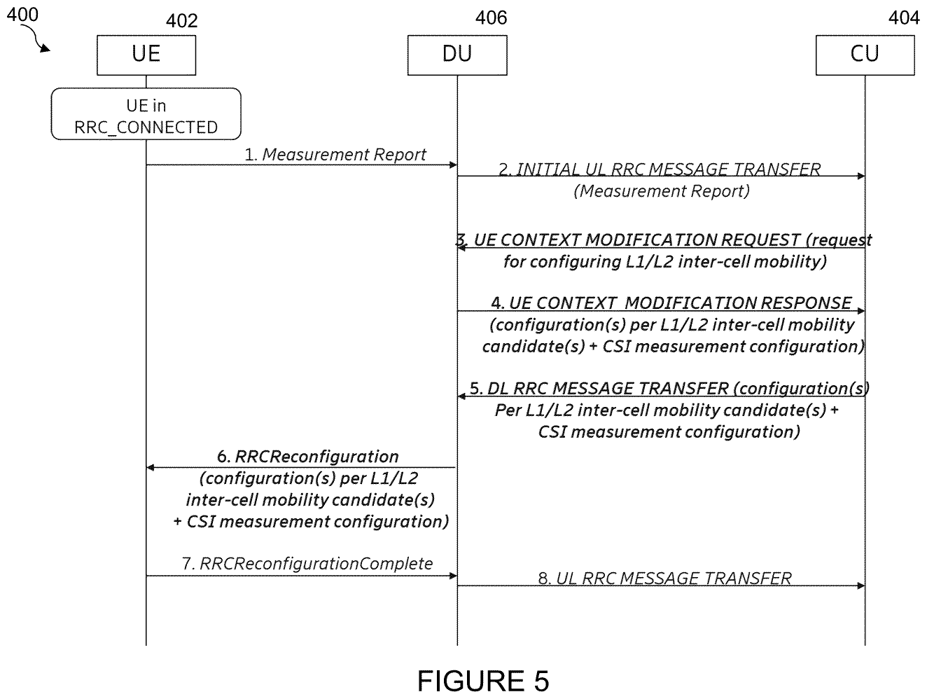

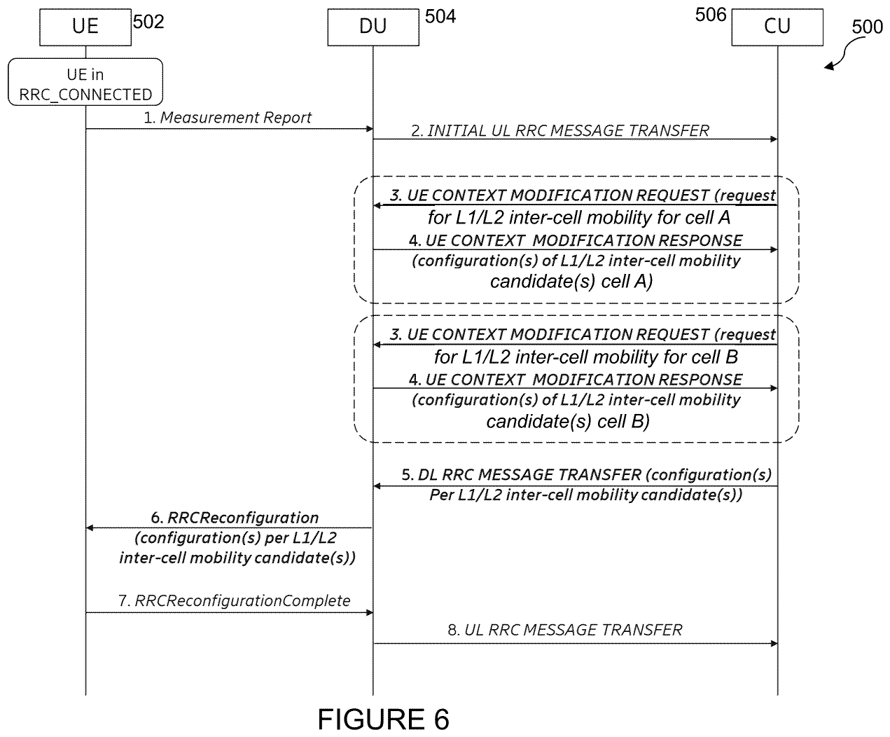

FIG. 5 illustrates an example signaling flow diagram 400 for configuring a UE 402 in RRC_CONNECTED for L1/L2 mobility, according to certain embodiments. Specifically, FIG. 6 illustrates the signaling flow for a UE 402, CU 404, and DU 406 and includes the following steps, which serve as reference to various different embodiments:
1. The UE 402 which is capable of L1/L2 inter-cell mobility sends or transmits a Measurement Report including one or more measurement s of one or more cells, which may become L1/L2 inter-cell mobility candidate cells in a first frequency.
   In a particular embodiment, the Measurement Report is transmitted after Access Stratum (AS) security has been activated.
   According to certain embodiments, the Measurement Report is an RRC Measurement Report message (MeasurementReport) wherein one or more measurements are included in, for example, the IE MeasResults, as defined in 3GPP TS 38.331. The one or more measurements of the one or more cells in a first frequency may be measurements of cells in the same frequency (or in a different frequency) as the Special Cell (SpCell) of the Master Cell Group/the Primary Cell (PCell), or intra-frequency neighbours of the PCell, or neighbours of configured SCell(s) of the MCG or/and the SCG. In a particular embodiment, the one or more measurements are one or more of:
      Cell measurement(s) or measurement results such as per cell RSRP, and/or per cell RSRQ and/or per cell SINR, based on a reference signal (e.g., a CSI-RS) and/or based on a synchronization signal (e.g., SSB).
      Beam measurement(s) or measurement results such as per cell RSRP, and/or per cell RSRQ and/or per cell SINR, based on a reference signal (e.g., a CSI-RS) and/or based on a synchronization signal (e.g., SSB). The beam measurements may be associated to a signal index/identifier or reference signal index/identifier, such as an SSB index or CSI-RS resource index/indicator.
   According to certain embodiments, the Measurement Report is a CSI report transmitted over the physical layer, also called L1, on an uplink channel of the PCell or one of the configured SCell(s) such as an PUSCH or a PUCCH in a UL channel format which includes the one or more measurements or information derived from the one or more measurements of the one or more L1/L2 inter-cell mobility candidate cells. The one or more measurements of the one or more L1/L2 inter-cell mobility candidate cells in a first frequency may be measurement of cells in the same frequency (or in a different frequency) as the Special Cell (SpCell) of the Master Cell Group/the Primary Cell (PCell), or intra-frequency neighbours of the PCell. In one embodiment, the one or more measurements are one or more of:
      Cell measurement(s) or measurement results such as per cell RSRP, and/or per cell RSRQ and/or per cell SINR, based on a reference signal (e.g., a CSI-RS) and/or based on a synchronization signal (e.g., SSB).
      Beam measurement(s) or measurement results such as per cell RSRP, and/or per cell RSRQ and/or per cell SINR, based on a reference signal (e.g., a CSI-RS) and/or based on a synchronization signal (e.g., SSB). The beam measurements may be associated to a signal index/identifier or reference signal index/identifier, such as an SSB index or CSI-RS resource index/indicator.
   According to certain embodiments, the Measurement Report (whether it is a CSI report or an RRC Measurement Report message) includes a number of measurements on one or more cells in a frequency that is equal to the number of L1/L2 inter-cell mobility candidate cells supported by the UE. This implies that the UE is able to keep stored (or apply) only a limited number of L1/L2 inter-cell mobility candidate cells based on its own capability. Alternatively, the Measurement Report (whether it is a CSI report or an RRC Measurement Report message) includes a number of measurements on one or more cells over all the frequencies configured that is equal to the number of L1/L2 inter-cell mobility candidate cells supported by the UE. This implies that the UE is able to keep stored (or apply) only a limited number of L1/L2 inter-cell mobility candidate cells based on its own capability.
      In a particular embodiment, the UE may decide to include in the measurement report only a number of measurements that is equal to that one of the numbers of L1/L2 inter-cell mobility candidate cells supported by the UE.
      In another particular embodiment, the UE may decide to include a number of measurements in a separate structure (e.g., an IE, a SEQUENCE, or field in the ASN.1) within the measurement report to indicate that that number is also the numbers of L1/L2 inter-cell mobility candidate cells supported by the UE. The UE may also include the rest of the measurements in yet a separate structure (e.g., an IE, a SEQUENCE, or field in the ASN.1).
      In a particular embodiment, the UE may decide to include one or more measurements available in the measurement report, but also to include in a separate structure (e.g., a field or an IE in the ASN.1) the numbers of L1/L2 inter-cell mobility candidate cells supported by the UE.
   According to certain embodiments, before transmitting the Measurement report, the UE receives a first message including a measurement configuration, wherein the measurement configuration comprises a reporting configuration associated a triggering criterion for the triggering of the Measurement Report when the triggering criterion is fulfilled.
      In a particular embodiment, the Measurement Report corresponds to an RRC Measurement Report, and the measurement configuration corresponds to the IE MeasConfig received in an RRC message (e.g., RRCReconfiguration), and the reporting configuration corresponds to the IE ReportConfig, which may configure a periodic measurement report (so that the triggering criterion would be the expiry of a timer and/or the periodicity which is configured) and/or an event-triggered measurement report (reportType set to ‘eventTriggered’) for an event such as A4 or A3, so that the triggering criterion would be the fulfillment of the event entering condition, as defined in 3GPP TS 38.331 (e.g., measurements on a neighbour cell an offset better than measurement on the PCell for a period of time longer than the configured time to trigger parameter).
         In the case of A4, the triggering condition for transmitting the measurement report is that at least one neighbour cell (or a possible L1/L2 inter-cell mobility candidate) becomes better than threshold (configured as part of the event configuration), for one or more measurement quantities such as RSRP, RSRQ, or/and SINR. In other words, if the UE detects at least one cell whose measurements fulfills the A4 condition (entering condition for A4 defined in details in 3GPP TS 38.331, § 5.5.4) the UE transmits the RRC Measurement Report and includes one or more measurement for the at least one cell. The reasoning here is that a cell that may trigger the report is considered as a neighbour as it is not the PCell, which is the cell the UE is configured with in the PCell frequency. The Measurement Object for the neighbour, in the case of intra-frequency, is the same frequency as the PCell.
         In the case of A3, the triggering condition for transmitting the measurement report is that at least one neighbour cell (or a possible L1/L2 inter-cell mobility candidate) becomes an offset better than SpCell (which in the case of single connectivity is the PCell), wherein the offset (or threshold, hysteresis) is configured as part of the event configuration, for one or more measurement quantities such as RSRP, RSRQ, or/and SINR. In other words, if the UE detects at least one cell whose measurements fulfill the A3 condition (entering condition for A3 defined in details in 3GPP TS 38.331, § 5.5.4) (i.e., a neighbour whose measurements are better than the measurements of the PCell), the UE transmits the RRC Measurement Report and includes one or more measurement for the at least one cell. The reasoning here is that a cell which may trigger the report is considered as a neighbour as it is not the PCell, which is the cell the UE is configured with in the PCell frequency. The Measurement Object for the neighbour, in the case of intra-frequency, is the same frequency as the PCell.
      In a particular embodiment, the Measurement Report corresponds to a CSI report, and the measurement configuration may correspond to the IE CSI-MeasConfig received in an RRC message (e.g., RRCReconfiguration), including the reporting configuration corresponding to the IE CSI-ReportConfig configuring a periodic, aperiodic, semi-persistent, and/or an event-triggered CSI report. In the case of event-triggered, the condition may be similar to the ones defined for RRC measurement reports.
      In a particular embodiment, the Measurement Report corresponds to a RRC Measurement Report or corresponds to a CSI report, and the measurement configuration may include a priority value for each cell based on which the UE should measure one or more cells in a first frequency. Alternatively, the measurement configuration may include a priority value for each frequency based on which frequency the UE should measure one or more cells for the frequency that needs to be prioritized. The highest priority value means that a cell or a frequency should be measured by the UE first or, alternatively, is the lowest priority value that means that a cell or a frequency should be measured first by the UE. In this case, the Measurement Report may include one or more measurements of the one or more cells in a first frequency may be measurement of cells in the same frequency (or in a different frequency) as the Special Cell (SpCell) of the Master Cell Group/the Primary Cell (PCell), or intra-frequency neighbors of the PCell, or neighbors of configured SCell(s) of the MCG or/and the SCG ordered based of the priority configured by the measurement configuration.
2. The DU (e.g., gNB-DU) which receives the Measurement Report includes the Measurement Report (e.g., RRC MeasurementReport message) in an UL RRC MESSAGE TRANSFER message to the CU (e.g., gNB-CU) and sends, to the CU, the received Measurement Report (e.g., MeasurementReport message). The CU receives the Measurement Report, encapsulated in the UL RRC MESSAGE TRANSFER message from the DU.
   In a particular embodiment, upon reception of the Measurement Report, the CU determines to configure the UE with one or more L1/L2 inter-cell mobility candidate cell(s). The CU may determine that based on at least one UE capability related to L1/L2 inter-cell mobility for the UE which has sent the Measurement Report.
   In a particular embodiment, upon reception of the Measurement Report, the CU determines one or more L1/L2 inter-cell mobility candidate cell(s), wherein at least one candidate cell is one of the cells for which measurements are included in the Measurement Report.
   According to certain embodiments, upon reception of the Measurement Report, the CU determines one or more L1/L2 inter-cell mobility candidate cell(s) based on the Measurement Report.
      In a particular embodiment, the one or more L1/L2 inter-cell mobility candidate cell(s) the CU determines are the cells in the Measurement Report whose measurement quantity (e.g., RSRP, RSRQ, and SINR) are the strongest or highest. For example, if the Measurement Report includes K cells, each having its associated measurement quantity (e.g., K RSRP values), and the UE is capable of being configured with K1<K L1/L2 inter-cell mobility candidates, the CU determines K1 cells to be the cells with the K1 strongest/highest RSRP values. The CU may be aware that one of these cells are associated to the DU the UE is connected to and may also be aware that one of these cells may be configured as a L1/L2 inter-cell mobility candidate.
      In a particular embodiment, the one or more L1/L2 inter-cell mobility candidate cell(s) the CU determines are the cells in the Measurement Report associated with the DU of the current PCell (i.e., the DU currently serving the UE, which may be considered a source DU).
3. The CU (e.g., gNB-CU) sends a second message to the DU of the RAN (e.g., gNodeB-DU), indicating a request for the DU to configure the UE with L1/L2 based inter-cell mobility. The request may comprise at least one cell and/or cell group which is/are L1/L2 inter-cell mobility candidate(s). The DU receives the second message including the request.
   In a particular embodiment, upon reception of the Measurement Report, the CU determines how many L1/L2 inter-cell mobility candidate cell(s) can be configured at the UE based on the number of measurements on one or more cells in a frequency that are included in the measurement report and/or based on the UE capabilities regarding the maximum number of candidates which may be configured. Alternatively, upon reception of the Measurement Report, the CU determines how many L1/L2 inter-cell mobility candidate cell(s) can be configured at the UE based on the number of measurements on one or more cells over all the frequencies that are included in the measurement report and/or based on the UE capabilities regarding the maximum number of candidates which may be configured.
   One Procedure per L1/L2 Inter-cell Mobility Candidate, Configuring One Candidate: According to certain embodiments, the CU transmits the second message to the DU of the RAN (e.g., gNodeB-DU), indicating a request for the DU to configure the UE with one L1/L2 based inter-cell mobility candidate cell, which is received by the DU, which transmits a response to the CU. The CU receives from the DU, in response to the second message, a third message including one configuration of a L1/L2 based inter-cell mobility candidate cell.
   One Procedure per L1/L2 Inter-cell Mobility Candidate, Configuring Multiple Candidates: According to certain other embodiments, the CU transmits multiple second message(s) to the DU of the RAN (e.g., gNodeB-DU). Each of the second messages indicate a request for the DU to configure the UE with one L1/L2 based inter-cell mobility candidate cell. The DU receives and responds. The CU receives from the DU, in response to each second message, a third message including one configuration of a L1/L2 based inter-cell mobility candidate cell.
   One Procedure per L1/L2 Inter-cell Mobility Candidate, Configuring Multiple Candidates: According to certain embodiments, the CU transmits the second message to the DU of the RAN (e.g., gNodeB-DU), indicating a request for the DU to configure the UE with multiple L1/L2 based inter-cell mobility candidate cell. The DU receives and responds. The CU receives from the DU, in response to the second message, a third message including one configuration for each of the L1/L2 based inter-cell mobility candidate cells to be configured.
   According to certain embodiments, the second message is a message used to modify the UE context in the DU, such as a UE Context Modification Request from CU to DU (UE CONTEXT MODIFICATION REQUEST over the FIAP interface). Hence, when the CU sends it, the CU is requesting the DU to modify the UE context by configuring L1/L2 inter-cell mobility, with one or more L1/L2 inter-cell mobility candidates.
   In a particular embodiment, the request includes one or more suggested/recommended L1/L2 inter-cell mobility candidate cell(s). Based on the one or more measurements or the subset of the one or more measurements, the CU may determine which cells to request the DU to configure (or to request the DU to configure) the UE with as L1/L2 inter-cell mobility candidates. Upon reception of the second message, the DU may determine which of the requested cells are to be configured for L1/L2 inter-cell base mobility, if a subset of them, if all of them, or none of them. The DU may have the option to configure a L1/L2 inter-cell mobility candidate which has not been suggested by the CU in the request, and in that case, the DU indicates the configuration(s) for the L1/L2 inter-cell mobility candidate.
   In a particular embodiment, the request includes the one or more measurements or a subset of the one or more measurements, or other content of the Measurement Report. Based on the one or more measurements or the subset of the one or more measurements, the DU may determine which cells to configure the UE with as L1/L2 inter-cell mobility candidates. In one option, the request does not include recommended cells, but only the one or more measurements, so that the DU selects which cells are to be configured as L1/L2 inter-cell mobility candidates. In another option, the request includes both the one or more measurements, but a recommended list of L1/L2 inter-cell mobility candidate cells determined by the CU.
   In a particular embodiment, the CU transmits the second message when the CU determines one or more L1/L2 inter-cell mobility candidate cell(s), wherein at least one candidate cell is one of the cells included in the Measurement Report.
   According to certain embodiments, the CU transmits the request in the second message based on at least one indication indicating that the UE is capable of L1/L2 based inter-cell mobility. That may be an indication that the CU has obtained.
      In a particular embodiment, the at least one indication is obtained by the CU from a Core Network node in a message, upon receiving a message such as an Initial Context Setup Request from the Access and Mobility Function (AMF). The message is sent over NG-1 interface between RAN and CN.
      In a particular embodiment, the at least one indication is obtained from the CU's memory or another memory in the network (e.g., in a UE context information).
      In a particular embodiment, the at least one indication is obtained via an explicit or implicit indication coming directly from the UE. The explicit indication may be obtained via the UE capability exchanged with the UE upon the establishment of the first RRC connection with this UE or via an explicit indication included in an RRC message sent by the UE to the CU (via the DU) such as the RRC Measurement Report. The implicit indication may be obtained by the presence of certain fields, information elements, or structures present in the RRC ASN.1, MAC CE, or SCI that are only used in case of L1/L2 based inter-cell mobility.
   The request in the message from the CU to the DU may comprise one or more of:
      a set of candidates to be SpCell(s); and/or
      a set of candidates to be SCell(s); and/or
      a set of candidate cell groups, including an SpCell L1/L2 inter-cell mobility candidate and at least one SCell associated to the SpCell L1/L2 inter-cell mobility candidate.
   One reason to include SCell candidates is that L1/L2 inter-cell mobility should work with Carrier Aggregation, so that upon executing L1/L2 inter-cell mobility to a target cell, which may be an SpCell candidate, the UE needs to be able to perform carrier aggregation with that SpCell after L1/L2 inter-cell mobility execution.
4. Upon reception of the request (in the second message), if the DU accepts the request for configuring L1/L2 inter-cell mobility for the UE, the DU generates (to later transmit to the CU) one or more of:
   at least one CSI measurement configuration;
   a first cell group configuration associated to the current Primary Cell (PCell); and
   at least one configuration of a L1/L2 based inter-cell mobility candidate cell.
Then, the DU transmits a third message to the CU.
The DU sends in response to the request one or more of:
   The configuration for each candidate to be SpCell(s); and/or
   The configuration for each candidate to be SCell(s); and/or
   The configuration for each candidate cell group, including the configuration of the SpCell L1/L2 inter-cell mobility candidate and the configuration for the at least one SCell associated to the SpCell L1/L2 inter-cell mobility candidate.
There could be different actions in case the DU does not accept the request for L1/L2 inter-cell mobility:
   According to certain embodiments, the DU indicates to the CU in the UE CONTEXT MODIFICATION RESPONSE message that configuring L1/L2 mobility was not successful, including an appropriate cause value (e.g., failure due to reason X
   According to certain embodiments, if the DU does not accept the request for L1/L2 inter-cell mobility, the DU indicates in the UE CONTEXT MODIFICATION FAILURE message that configuring L1/L2 mobility was not successful with an appropriate cause value.
   According to certain embodiments, if the DU does not accept the request for configuring the L1/L2 based inter-cell mobility candidate cell(s) requested by the CU, but may configure other L1/L2 based inter-cell mobility candidate cell(s), the DU indicates such L1/L2 based inter-cell mobility candidate cell(s) that can be configured in the UE CONTEXT MODIFICATION RESPONSE or UE CONTEXT MODIFICATION FAILURE message together with a cause value. In this latter case, when receiving the UE CONTEXT MODIFICATION RESPONSE or UE CONTEXT MODIFICATION FAILURE message with L1/L2 based inter-cell mobility candidate cell(s) not originally requested by the CU, the CU may send a new message to the DU to trigger a new UE Context Modification Request procedure (i.e., for configuring all, or a subset of, the L1/L2 based inter-cell mobility candidate cell(s) suggested by the DU).
   Further, if one or more L1/L2 inter-cell mobility candidates (possible encoded in F1AP with an IE (e.g., Candidate L1/L2Cell List IE) is included in the UE CONTEXT MODIFICATION REQUEST message and the DU (e.g., gNB-DU) accepts a subset of these candidates, the DU (e.g., gNB-DU) shall, if it can support L1/L2 inter-cell mobility, respond including the accepted subset (e.g., a list of accepted cells, possibly encoded ain an IE of F1AP (e.g., L1/L2Cell List IE)) comprising the subset of the cells (e.g., in the Candidate L1/L2Cell List IE) that can be accepted and possibly additional cells that the DU decided to add for L1/L2 inter-cell mobility in the UE CONTEXT MODIFICATION RESPONSE message and the CU (e.g., gNB-CU) shall take this into account. In one option, the gNB-DU shall include the cells in the L1/L2Cell List IE in a priority order, where the first cell in the list is the one most desired and the last one is the one least desired (e.g., based on measurements and/or load conditions).
   A summary of the actions at the DU depending on the CU request for one or more L1/L2 inter-cell mobility candidates is the following:
      The DU accepts all requested candidates, possibly adding at least one more candidate cell. The configurations of these cells are sent in response to the CU.
      The DU accepts a subset of the suggested candidate cells and maybe has identified again some on its own. All the accepted cells are signalled in the response message. All the failed cells are also signalled with an appropriate cause value.
      The DU can't accept any of the cells from the CU but it has identified cells on its own. Then similar procedure as in alt 2
      The DU can't accept any of the cells in the CU and it has not identified any cells on its own. Then the DU sends a UE Context modification failure message, if the L1/L2 mobility was the reason of the UE context modification procedure.
   In a particular embodiment, the third message is a UE Context Modification Response (F1AP message).
   In a particular embodiment, the third message is a UE Context Modification Response (F1AP message) transmitted by the DU in response to the second message. The CU receives the third message.
5. Upon reception of the third message (e.g., UE Context Modification Response) the CU transmits to the DU a fourth message comprising an RRC Reconfiguration to be transmitted to the UE, wherein the RRC Reconfiguration comprises the one or more of:
   the at least one CSI measurement configuration;
   the first cell group configuration associated to the current Primary Cell (PCell) in which the UE has transition from RRC_IDLE to RRC_CONNECTED;
   The least one configuration of a L1/L2 based inter-cell mobility candidate cell; Then, the DU receives the fourth message:
      In a particular embodiment, the fourth message comprises a DL RRC MESSAGE TRANSFER.
      In a particular embodiment, the fourth message is another UE Context Modification Request from CU to DU;
      In a particular embodiment, before transmitting the fourth message, the CU generates the RRC Reconfiguration. That includes the at least one configuration of a L1/L2 based inter-cell mobility candidate cell for a candidate that has been suggested by the CU and accepted by the DU and/or a candidate configured by the DU without being suggested by the CU. For example, the CU (e.g., gNB-CU) generates the RRCReconfiguration message and encapsulates it in the DL RRC MESSAGE TRANSFER message. The RRCReconfiguration message comprises the necessary configurations for the UE to perform L1/L2 inter-cell mobility and related procedures such as CSI measurements and reports associated. The RRC Reconfiguration (RRCReconfiguration) message comprises the information generated by the DU for L1/L2 inter-cell mobility.
6. The DU transmits to the UE the RRC Reconfiguration message (which has been encapsulated in the fourth message), for configuring the one or more L1/L2 inter-cell mobility candidates. The DU transmits the RRC Reconfiguration message to the UE in response to the reception of the fourth message from the CU. The UE receives the RRC Reconfiguration message and applies the message including the one or more of:
   at least one CSI measurement configuration;
   a first cell group configuration associated to the current Primary Cell (PCell) in which the UE has transition from RRC_IDLE to RRC_CONNECTED;
   at least one configuration of a L1/L2 based inter-cell mobility candidate cell;
The UE, upon receiving the RRC Reconfiguration, applies the message and is configured with L1/L2 inter-cell mobility candidate(s) and CSI measurement configuration to support L1/L2 inter-cell mobility.
7. The UE sends RRCReconfigurationComplete message to the DU (e.g., gNB-DU). The DU receives the message.
8. The DU (e.g., gNB-DU) encapsulates the RRC message in the UL RRC MESSAGE TRANSFER message and send it to the CU (e.g., gNB-CU). The CU receives the message and considers the UE configured with L1/L2 inter-cell mobility.

From the UE's perspective, after step 7, the UE starts to perform CSI measurements on one or more L1/L2 inter-cell mobility candidates and reports to the DU. Upon reception, the DU may determine to trigger L1/L2 inter-cell mobility by transmitting to the UE a lower layer signalling (e.g., MAC CE or DCI) indicating to the UE to change its serving cell (e.g., change of PCell). Upon reception of the lower layer signalling, the UE changes its serving cell and operates according to the configuration of the L1/L2 inter-cell mobility candidate indicated by the lower layer signalling. The configuration of the L1/L2 inter-cell mobility candidate has been received in Step 7.

The lower layer signaling from the network (e.g., from the DU) may be a MAC CE or a DCI comprising an indication indicating at least one configured L1/L2 based inter-cell mobility candidate cell which the UE needs to change to in L1/L2 inter-cell mobility. After receiving the lower layer signaling, the UE starts to operate in the L1/L2 based inter-cell mobility candidate cell according to the configuration of the L1/L2 based inter-cell mobility candidate cell.

### Further Details on the Signaling Between CU and DU (F1AP Procedures)

Some different aspects are further detailed in this section:
The usage of a single or multiple procedures for configuring multiple L1/L2 inter-cell mobility candidate cells.
The configuration of L1/L2 inter-cell mobility candidate cells to become a PCell and/or an SCell, or the configuration of a cell group (e.g. IE CellGroupConfig) for a given L1/L2 inter-cell mobility candidate cell.

### One Procedure Per L1/L2 Inter-Cell Mobility Candidate

According to a certain embodiments, one candidate is configured. For example, according to certain embodiments, the CU transmits the second message to the DU of the RAN (e.g., gNodeB-DU), such as a UE CONTEXT MODIFICATION REQUEST, indicating a request for the DU to configure the UE with one L1/L2 based inter-cell mobility candidate cell, and receiving from the DU, in response to the second message, a third message (such as a UE CONTEXT MODIFICATION RESPONSE) including one configuration of a L1/L2 based inter-cell mobility candidate cell. The message may contain an indication of the candidate cell (e.g., candidate PCell) such as a cell identifier (e.g., an NR CGI, as defined in 3GPP TS 38.331).

According to certain other embodiments, multiple candidates are configured. For example, according to certain embodiments, the CU transmits multiple second message(s) to the DU of the RAN (e.g. gNodeB-DU), each of the second messages indicating a request for the DU to configure the UE with one L1/L2 based inter-cell mobility candidate cell, and receiving from the DU, in response to each second message, a third message including one configuration of a L1/L2 based inter-cell mobility candidate cell. In other words, the CU requests the DU to configure multiple candidates, and for each candidate the CU triggers a modification procedure by sending the UE CONTEXT MODIFICATION REQUEST including an indication of the L1/L2 inter-cell mobility candidate cell being requested.

FIG. 6 illustrates example signaling 500 between a UE 502, DU 504, and CU 506 where each procedure configures each L1/L2 inter-cell mobility candidate, according to certain embodiments. Specifically, FIG. 6 illustrates the CU 506 receiving a Measurement Report with measurements for cell A and cell B, for example.

The CU determines to request the DU to configure cell A and cell B as L1/L2 inter-cell mobility candidate cells.
The CU transmits a UE CONTEXT MODIFICATION REQUEST to the DU, indicating the request for cell A, and receives in response from the DU a UE CONTEXT MODIFICATION RESPONSE including the configuration for L1/L2 inter-cell mobility for cell A.
The CU transmits another UE CONTEXT MODIFICATION REQUEST to the DU, indicating the request for cell B, and receives in response from the DU a UE CONTEXT MODIFICATION RESPONSE including the configuration for L1/L2 inter-cell mobility for cell B.

When both responses are received, the CU generates the RRC Reconfiguration for the UE, encapsulates it in the DL RRC MESSAGE TRANSFER to the DU, and transmits it to the DU. The DU transmits it to the UE, so the UE is configured with both cell A and cell B as L1/L2 inter-cell mobility candidate cells.

One advantage of this approach is that the CU/DU messages require fewer updates, so that DU implementation may be simpler, as the DU is currently used to handle a message requesting one cell to be added for other legacy procedures. Further, another advantage is that if the DU fails to configure one of the cell (e.g., cell A or cell B), still the L1/L2 inter-cell mobility can be configured at the UE with the other cell (for which the DU was able to generate the configuration).

### One Procedure for Multiple L1/L2 Inter-Cell Mobility Candidates

According to certain embodiments, the CU transmits the second message to the DU of the RAN (e.g., gNodeB-DU), such as a UE CONTEXT MODIFICATION REQUEST, indicating a request for the DU to configure the UE with a plurality of L1/L2 based inter-cell mobility candidate cells, and receiving from the DU, in response to the second message, a third message (such as a UE CONTEXT MODIFICATION RESPONSE) including a plurality of configurations, wherein each configuration corresponds to a L1/L2 based inter-cell mobility candidate cell from the plurality of L1/L2 inter-cell mobility candidate cells.

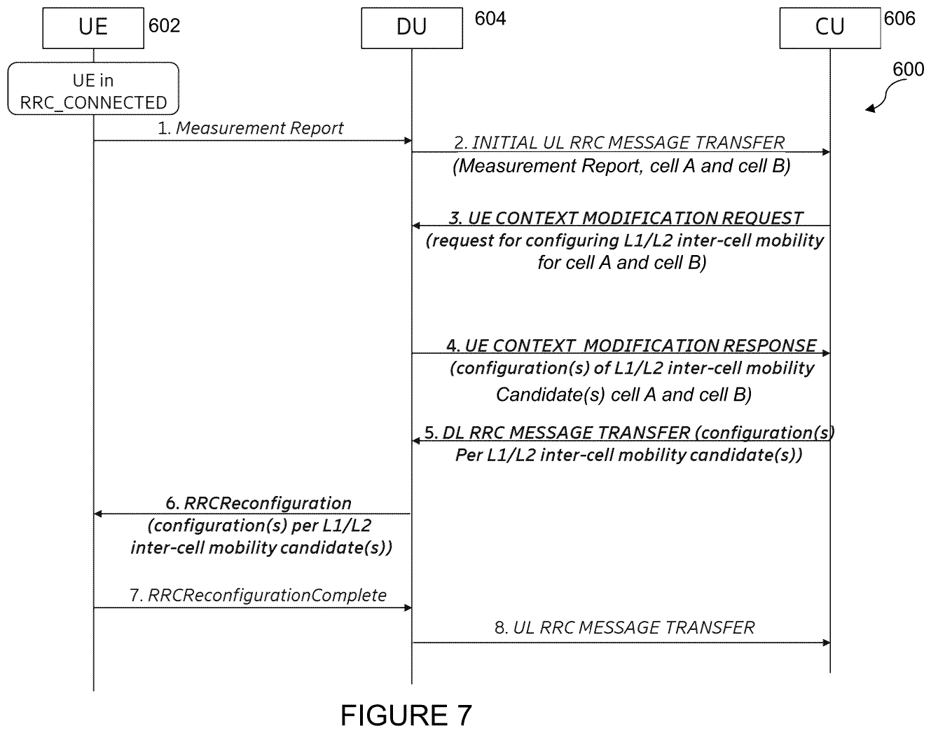

FIG. 7 illustrates another example signaling 600 between a UE 602, DU 604, and CU 606 where a single procedure may be triggered to configure multiple L1/L2 inter-cell mobility candidates. Specifically, FIG. 7 illustrates the CU receiving a Measurement Report with measurements for cell A and cell B.

The CU determines to request the DU to configure cell A and cell B as L1/L2 inter-cell mobility candidate cells.
The CU transmits a UE CONTEXT MODIFICATION REQUEST to the DU, indicating the request for both cell A and cell B, and in response from the DU, receives a UE CONTEXT MODIFICATION RESPONSE including the configuration for L1/L2 inter-cell mobility for cell A and the configuration for L1/L2 inter-cell mobility for cell B.

When the single response is received, the CU generates the RRC Reconfiguration message for the UE, encapsulates it in the DL RRC MESSAGE TRANSFER to the DU, and transmits it to the DU. The DU transmits it to the UE, so the UE is configured with both cell A and cell B as L1/L2 inter-cell mobility candidate cells.

One advantage of this approach is the reduced signaling as a single CU/DU message may configure multiple candidates. A further advantage is that the overall procedure to configure the L1/L2 inter-cell mobility for cell A and cell B is faster.

Configuring L1/L2 Inter-Cell Mobility Candidate Cells as SpCell(s), SCell(s), and/or Cell Group(s)

L1/L2 inter-cell mobility may be configured for at least one SpCell which is a L1/L2 inter-cell mobility candidate. In that case, the UE is connected to a source cell (source SpCell) and the reception of the lower layer signalling after the UE has been configured with at least one L1/L2 inter-cell mobility candidate indicates a change of that source SpCell to a target SpCell which is one of the configured L1/L2 inter-cell mobility candidate(s) the UE is configured with.

L1/L2 inter-cell mobility may be configured for at least one SCell which is a L1/L2 inter-cell mobility candidate. In that case, the UE has configured and operates accordingly to an SCell (e.g., of the Master Cell Group, which is an activated SCell) and the reception of the lower layer signalling after the UE has been configured with at least one L1/L2 inter-cell mobility candidate SCell indicates a change of that SCell to a different SCell, possibly in that same frequency, wherein the different SCells is one of the configured L1/L2 inter-cell mobility candidate(s) the UE is configured with.

L1/L2 inter-cell mobility may be configured for at least a cell group, comprising one SpCell which is a L1/L2 inter-cell mobility candidate and one or more SCell(s)), upon reception of a cell group configuration (IE CellGroupConfig). In that case, the UE is connected to a source cell (source SpCell) and may be configured with one or more SCell(s) of the MCG, and the reception of the lower layer signalling, after the UE has been configured with at least one L1/L2 inter-cell mobility candidate, indicates a change of that source SpCell to a target SpCell which is one of the configured L1/L2 inter-cell mobility candidate(s) the UE is configured with, and a change of at least one of the configured SCell(s) (e.g., one new SCell being added, one of the configured SCell(s) being removed or modified).

According to certain embodiments, the request (e.g., in the UE CONTEXT MODIFICATION REQUEST from the CU to DU) comprises at least one set of cells (e.g., in a list), which are L1/L2 inter-cell mobility candidates (e.g., Candidate L1/L2Cell List IE, possibly including a list of cell identifiers for the requested cells). The set may be encoded as a list or any other data structure (e.g., defined in RRC signalling).

According to certain embodiments, the at least one set of cells corresponds to a set of SpCell candidates for L1/L2 inter-cell mobility. These are candidate cells in the same or in a different frequency (SSB frequency and/or SSB subcarrier spacing) as the UE's current SpCell (e.g., PCell) the UE is configured with.
In a particular embodiment, the DU receives these set of SpCell(s) and generates a configuration per L1/L2 based inter-cell mobility candidate SpCell and sends to the CU (e.g., IE SpCellConfig within the UE CONTEXT MODIFICATION RESPONSE).
In a particular embodiment, the DU receives these set of SpCell(s) and generates a cell group configuration (e.g., IE CellGroupConfig) per L1/L2 based inter-cell mobility candidate SpCell, which also comprises for each L1/L2 based inter-cell mobility candidate SpCell one or more SCell(s) configuration(s) associated to the candidate SpCell.
   In a further particular embodiment, the one or more SCell(s) per L1/L2 inter-cell mobility candidate SpCell included by the DU in the cell group configuration per L1/L2 inter-cell mobility candidate is one of the SCell(s) indicated by the CU in the UE CONTEXT MODIFICATION REQUEST message.
   In another particular embodiment, the one or more SCell(s) per L1/L2 inter-cell mobility candidate included by the DU in the cell group configuration per L1/L2 inter-cell mobility candidate is not one of the SCell(s) indicated by the CU in the UE CONTEXT MODIFICATION REQUEST message.

According to certain embodiments, the at least one set of cells corresponds to a (suggested, requested) set of Secondary Cell (SCell) candidates for L1/L2 inter-cell mobility (e.g., for carrier aggregation). These are candidate cells in the same or in a different frequency (SSB frequency and/or SSB subcarrier spacing) as the UE's current SpCell (e.g., PCell).
In a particular embodiment, the DU receives these recommended set of SCell(s) and generates a configuration per L1/L2 based inter-cell mobility candidate SCell and sends it to the CU (e.g., IE SCellConfig within the UE CONTEXT MODIFICATION RESPONSE).

According to certain embodiments, the DU receives from the CU a first set of cells corresponding to a set of SpCell candidates for L1/L2 inter-cell mobility and a second set of cells corresponding to a set of SCell candidates for L1/L2 inter-cell mobility. Upon reception, the DU generates at least one cell group configuration which comprises the SpCell Configuration for at least one of the SpCell candidates, and the SCell configuration for at least one of the SCell candidates.
In a particular embodiment, the second set of cells corresponding to a set of SCell candidates for L1/L2 inter-cell mobility is the same set of SCells indicated the UE CONTEXT MODIFICATION REQUEST message to be SCell(s) of the current PCell's cell group configuration e.g. included in the IE SCell To Be Setup List.
In a particular embodiment, the second set of cells corresponding to a set of SCell candidates for L1/L2 inter-cell mobility is indicated in as a different set of SCells in the UE CONTEXT MODIFICATION REQUEST message compared to the SCell(s) of the current PCell's cell group configuration (e.g., included in the IE SCell To Be Setup List), even though the CU may choose to include the same SCells in both lists, one for the current PCell cell group configuration, and for a L1/L2 inter-cell mobility candidate PCell.
In a particular embodiment, the two sets are sent by the CU and received by the DU as separated sets (e.g., in two lists of cells). The DU determines how these SpCell candidates and SCell candidates are grouped or combined in cell group configuration(s). For example, if the first set of cells is SPCell Id=1, SpCell Id=2, and the second set is Scell Id=4, SCell Id=5, the DU may generate for L1/L2 inter-cell mobility the SpCellConfig(1) for SpCell Id=1, SCellConfig(4) for Scell Id=4, SCellConfig(5) for Scell Id=5, and the cell group CellGroupConfig(1)=SpCellConfig(1)+SCellConfig(4) and SCellConfig(5), wherein the CellGroupConfig(1) is provided to the CU in the UE CONTEXT SETUP RESPONSE.

According to certain embodiments, the DU receives from the CU a set of cell group(s), comprising one SpCell candidate for L1/L2 inter-cell mobility and at least one SCell candidate for L1/L2 inter-cell mobility. Upon reception, the DU generates at least one cell group configuration that comprises the SpCell configuration for the SpCell candidate and the SCell configuration for the SCell candidate. In this option, it is the CU that requests a specific cell group as a candidate cell group, including both the PCell and one or more SCell(s), while the DU determines to accept or not a cell group being requested as candidate for L1/L2 inter-cell mobility.

According to certain embodiments, an IE is included in the UE CONTEXT MODIFICATION REQUEST message indicating one or more L1/L2 inter-cell mobility candidate cells (e.g., the Candidate L1/L2Cell List IE) which are being requested (or suggested or recommended) by the CU to the DU, such as an IE name (e.g., Candidate L1/L2Cell List IE), comprising one or more of:
Cell identifier for each L1/L2 inter-cell mobility candidate cell.
   In one embodiment, the cell identifier per L1/L2 inter-cell mobility candidate is provided as one or more Global Cell Identity(ies) (e.g., NR CGI(s), physical cell identities (and associated frequency), PLMN Identity and associated NR Cell Identity).
   In one embodiment, the cell identifier per L1/L2 inter-cell mobility candidate is provided as an extended version of the IE Candidate SpCell List (defined in TS 38.473) and in the case of L1/L2 inter-cell mobility candidate(s) being requested may have more values (e.g., 0, 1, 2, 3 . . . . K). When that is used, the CU includes in the first value in the list the cell which the CU intends to be the current SpCell, i.e. PCell the UE is connected to, while the other cells included are intended to be the L1/L2 inter-cell mobility candidate cell(s). They may be considered as SpCell candidates for L1/L2 inter-cell mobility.
Cell index, encoded with fewer bits than the Cell identifier, for each L1/L2 inter-cell mobility candidate cell.
   In one embodiment, the cell index per L1/L2 inter-cell mobility candidate is provided as an integer. That index is to be used for the communication between the UE and/or the CU and/or the DU to refer to that cell. This may be especially important over the air interface, to exchange a reduced number of bits when referring to that candidate cell. This makes sense as there may be more L1/L2 inter-cell mobility candidates overall than L1/L2 inter-cell mobility candidates the UE may be configured with.
Frequency information for each for each L1/L2 inter-cell mobility candidate cell.
   In one embodiment, the frequency information comprises an indication of a serving measurement object or serving frequency (e.g., a servingCellMO as defined in 3GPP TS 38.331), and associated to the measurement object of the serving frequency in which the L1/L2 inter-cell mobility candidate is.
   In one embodiment, the frequency information comprises an SSB frequency, possibly encoded as an absolute frequency information (e.g., ARFCN, as defined in 3GPP TS 38.331).
   In one embodiment, the frequency information comprises a CSI-RS frequency, possibly encoded as an absolute frequency information (e.g., ARFCN, as defined in 3GPP TS 38.331).
   In one embodiment, the frequency information comprises a point A frequency, possibly encoded as an absolute frequency information (e.g., ARFCN, as defined in 3GPP TS 38.331).
A cell group index or identifier for each L1/L2 inter-cell mobility candidate cell and/or L1/L2 inter-cell mobility candidate cell group.

### Signaling Example

Below is an example of the UE CONTEXT MODIFICATION REQUEST message from the CU to the DU (e.g., over F1AP, from a gNB-CU to a gNB-DU) when the L1/L2 inter-cell mobility is requested to be configured for at least one SpCell which is a L1/L2 inter-cell mobility candidate.

8.3.4 UE Context Modification (gNB-CU Initiated)
[ . . . ]

If the Candidate L1/L2Cell List IE is included in the UE CONTEXT MODIFICATION REQUEST message, the gNB-DU shall consider that these cells are recommended for L1/L2 mobility and will take them under consideration.

If the L1/L2Cell List IE is included in the UE CONTEXT MODIFICATION REQUEST message the gNB-DU will understand that the cells are configured for L1/L2 mobility.

If the L1/L2CellGroupConfig IE is included in the CU to DU RRC Information IE in the UE CONTEXT MODIFICATION REQUEST message, the DU will understand that it provides configurations of cells for L1/L2 mobility.

If the gNB-DU is not able to accept any of the cells in the Candidate L1/L2Cell List IE, the gNB-DU shall respond with an appropriate cause value in the UE CONTEXT MODIFICATION RESPONSE message.

If the L1/L2Cell List IE is included in the UE CONTEXT MODIFICATION RESPONSE message the gNB-CU will understand that the cells are configured for L1/L2 mobility. The gNB-DU shall include the cells in the L1/L2Cell List IE in a priority order, where the first cell in the list is the one most desired and the last one is the one least desired (e.g., based on measurements, load conditions

If the L1/L2CellGroupConfig IE is included in the DU to CU RRC Information IE in the UE CONTEXT MODIFICATION RESPONSE message, the CU will understand that it provides configurations of cells for L1/L2 mobility.

If the Candidate L1/L2 SCell To Be Setup List IE is included in the UE CONTEXT MODIFICATION REQUEST message, the gNB-DU shall consider it as a list of candidate SCells recommended for L1/L2 inter-cell mobility and will take them under consideration. The recommended cells may correspond to requested cell or suggested cells.

If the L1/L2 SCell List IE is included in the UE CONTEXT MODIFICATION RESPONSE message the gNB-CU will understand that the Scells are configured for L1/L2 mobility.

If the L1/L2 SCell Failed To Setup List IE is contained in the UE CONTEXT MODIFICATION RESPONSE message, the gNB-CU shall regard the corresponding SCell(s) for L1/L2 inter-cell mobility failed to be set up with an appropriate cause value for each SCell failed to setup.

If the L1/L2 Cell Failed To Setup List IE is contained in the UE CONTEXT MODIFICATION RESPONSE message, the gNB-CU shall regard the corresponding Cell(s) for L1/L2 inter-cell mobility failed to be set up with an appropriate cause value for each Cell failed to setup.

### 8.3.4.3 Unsuccessful Operation

[ . . . ]

If the gNB-DU is not able to accept any of the cells in the Candidate L1/L2 SCell To Be Setup List IE in UE CONTEXT MODIFICATION REQUEST message, it shall reply with the UE CONTEXT MODIFICATION FAILURE message with an appropriate cause value.

### 8.4.2 DL RRC Message Transfer

If the L1/L2CellGroupConfig IE is included in the RRC-Container IE in the DL RRC MESSAGE TRANSFER message, the DU will understand that it provides configurations of cells for L1/L2 mobility.

### 9.2.2.7 Ue Context Modification Request

This message is sent by the gNB-CU to provide UE Context information changes to the gNB-DU.

Direction: gNB-CU→gNB-DU

| | | | IE type and | Semantics | | Assigned |
|---|---|---|---|---|---|---|
| IE/Group Name | Presence | Range | reference | description | Criticality | Criticality |
| . . . | | | | | | |
| Candidate | | 0 . . . 1 | | | YES | ignore |
| L1/L2Cell List | | | | | | |
| >Candidate | | 1 . . . | | | EACH | ignore |
| L1/L2Cell Item IEs | | <maxnoofL1/L2Cells> | | | | |
| >>Candidate | M | | NR CGI | | — | |
| L1/L2Cell ID | | | 9.3.1.12 | | | |
| L1/L2Cell List | | 0 . . . 1 | | | YES | ignore |
| >L1/L2Cell Item | | 1 . . . | | | EACH | ignore |
| IEs | | <maxnoofL1/L2Cells> | | | | |
| >>L1/L2Cell ID | M | | NR CGI | | — | |
| | | | 9.3.1.12 | | | |
| Candidate L1/L2 | | 0 . . . 1 | | | YES | ignore |
| SSCell To Be | | | | | | |
| Setup List | | | | | | |
| >Candidate | | 1 . . . | | | EACH | ignore |
| L1/L2 SCell to Be | | <maxnoofL1/L2SCells> | | | | |
| Setup Item IEs | | | | | | |
| >>SCell ID | M | | NR CGI | SCell | — | |
| | | | 9.3.1.12 | Identifier in | | |
| | | | | gNB | | |
| >>SCellIndex | M | | INTEGER | | — | |
| | | | (1 . . . 31) | | | |
| >>SCell UL | O | | Cell UL | | — | |
| Configured | | | Configured | | | |
| | | | 9.3.1.33 | | | |
| >>servingCellMO | O | | INTEGER | | YES | ignore |
| | | | (1 . . . 64) | | | |

| Range bound | Explanation |
|---|---|
| . . . | |
| MaxnoofL 1/L2Cells | Maximum no. of Cells configured |
| | for L1/L2 mobility allowed towards |
| | one UE, the maximum value is FFS. |
| MaxnoofL 1/L2SCells | Maximum no. of SCells allowed |
| | towards one UE, the maximum |
| | value is FFS. |

| Condition | Explanation |
|---|---|
| ifCHOcancel | This IE may be present if the CHO |
| | Trigger IE is present and set to |
| | “CHO-cancel”. |

### 9.2.2.8 Ue Context Modification Response

This message is sent by the gNB-DU to confirm the modification of a UE context. Direction: gNB-DU→gNB-CU.

| | | | IE type and | Semantics | | Assigned |
|---|---|---|---|---|---|---|
| IE/Group Name | Presence | Range | reference | description | Criticality | Criticality |
| . . . | | | | | | |
| L1/L2Cell List | | 0 . . . 1 | | | YES | ignore |
| >L1/L2Cell Item | | 1 . . . | | | EACH | ignore |
| IEs | | <maxnoofL1/L2Cells> | | | | |
| >>L1/L2Cell ID | M | | NR CGI | | — | |
| | | | 9.3.1.12 | | | |
| L1/L2 SSCell | | 0 . . . 1 | | | YES | ignore |
| Setup List | | | | | | |
| >Candidate | | 1 . . . | | | EACH | ignore |
| L1/L2 SCell | | <maxnoofL1/L2SCells> | | | | |
| Setup Item IEs | | | | | | |
| >>L1/L2SCell ID | M | | NR CGI | SCell | — | |
| | | | 9.3.1.12 | Identifier in | | |
| | | | | gNB | | |
| >>SCellIndex | M | | INTEGER | | — | |
| | | | (1 . . . 31) | | | |
| >>SCell UL | O | | Cell UL | | — | |
| Configured | | | Configured | | | |
| | | | 9.3.1.33 | | | |
| >>servingCellMO | O | | INTEGER | | YES | ignore |
| | | | (1 . . . 64) | | | |
| L1/L2 SCell Failed | | 0 . . . 1 | | | YES | ignore |
| To Setup List | | | | | | |
| >L1/L2 SCell | | 1 . . . | | | EACH | ignore |
| Failed to Setup | | <maxnoofL1/L2SCells> | | | | |
| Item | | | | | | |
| >>L1/L2SCell | M | | NR CGI | SCell | — | |
| ID | | | 9.3.1.12 | Identifier in | | |
| | | | | gNB | | |
| >>Cause | O | | 9.3.1.2 | | — | |
| L1/L2 Cell Failed | | 0 . . . 1 | | | YES | ignore |
| To Setup List | | | | | | |
| >L1/L2 Cell | | 1 . . . | | | EACH | ignore |
| Failed to Setup | | <maxnoofL1/L2Cells> | | | | |
| Item | | | | | | |
| >>L1/L2Cell ID | M | | NR CGI | | — | |
| | | | 9.3.1.12 | | | |
| >>Cause | O | | 9.3.1.2 | | — | |

| Range bound | Explanation |
|---|---|
| . . . | |
| MaxnoofL 1/L2Cells | Maximum no. of Cells configured |
| | for L1/L2 mobility allowed towards |
| | one UE, the maximum value is FFS. |
| MaxnoofL 1/L2SCells | Maximum no. of SCells allowed towards |
| | one UE, the maximum |
| | value is FFS. |

### 9.3.1.25 CU to DU RRC Information

This IE contains the RRC Information that are sent from gNB-CU to gNB-DU.

| | | | IE type and | Semantics | | Assigned |
|---|---|---|---|---|---|---|
| IE/Group Name | Presence | Range | reference | description | Criticality | Criticality |
| . . . | | | | | | |
| L1/L2 | | 0 . . . 1 | | | YES | ignore |
| CellGroupConfig | | | | | | |
| List | | | | | | |
| > L1/L2 | | 1 . . . | | | EACH | ignore |
| CellGroupConfig | | <maxnoofL1/L2Cells> | | | | |
| Item IEs | | | | | | |
| >> L1/L2 | M | | OCTET | CellGroupConfig | — | |
| CellGroupConfig | | | STRING | for L1/L2 | | |
| | | | | mobility cells, as | | |
| | | | | defined in TS | | |
| | | | | 38.331 [8]. | | |

| Range bound | Explanation |
|---|---|
| MaxnoofL 1/L2Cells | Maximum no. of Cells configured |
| | for L1/L2 mobility allowed towards |
| | one UE, the maximum value is FFS. |

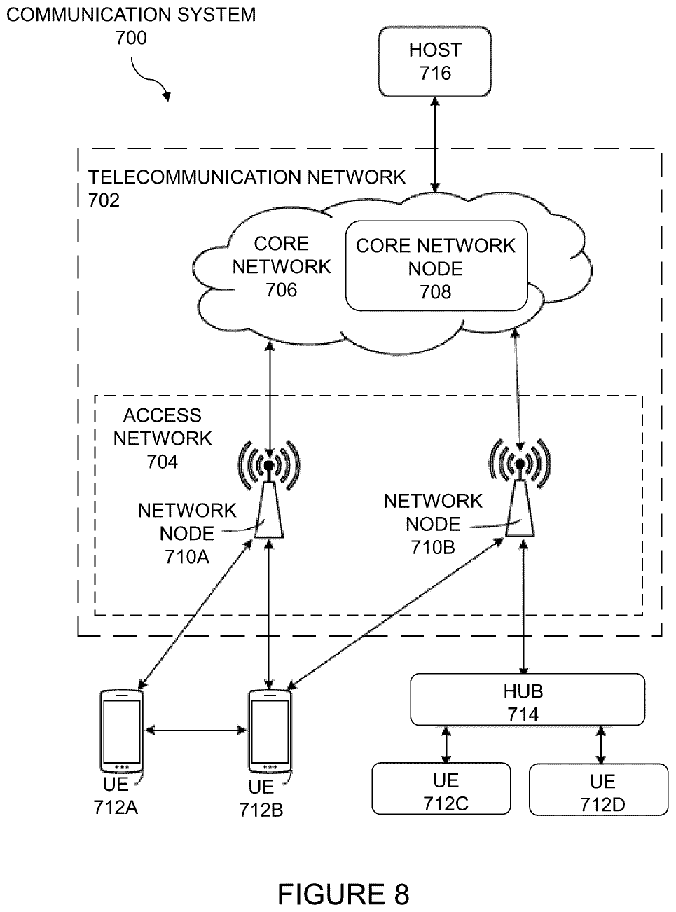

FIG. 8 shows an example of a communication system 700 in accordance with some embodiments. In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

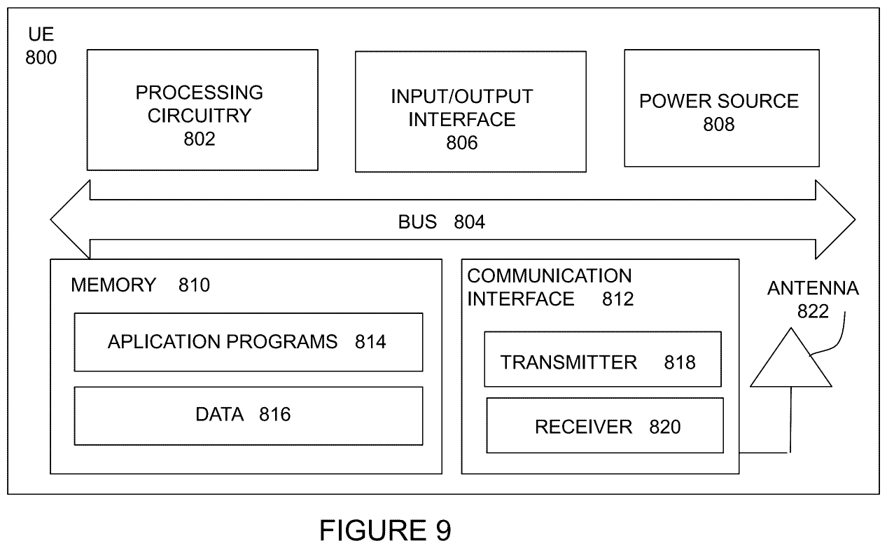

FIG. 9 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

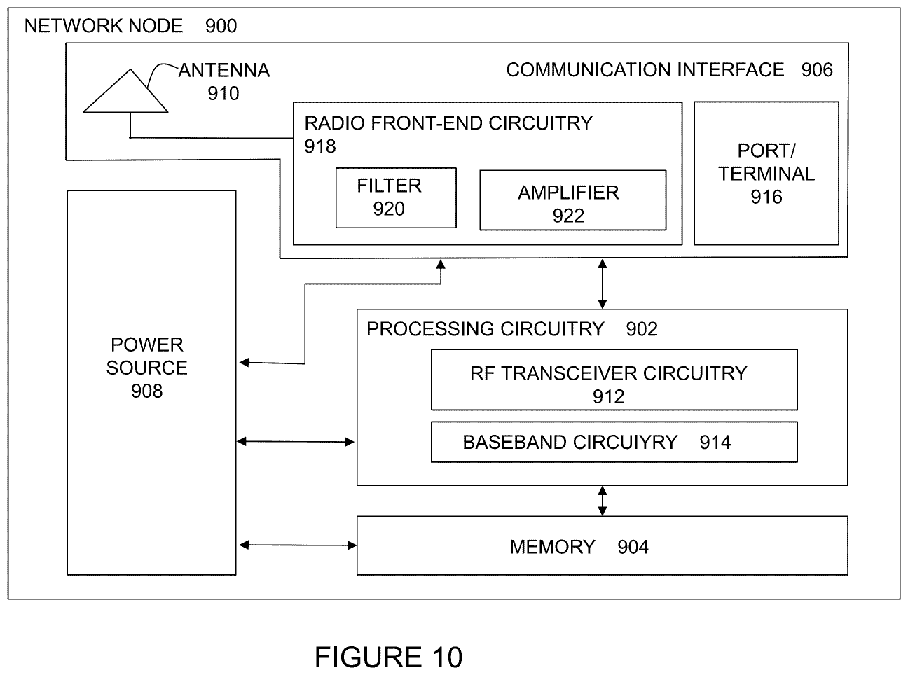

FIG. 10 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 10 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

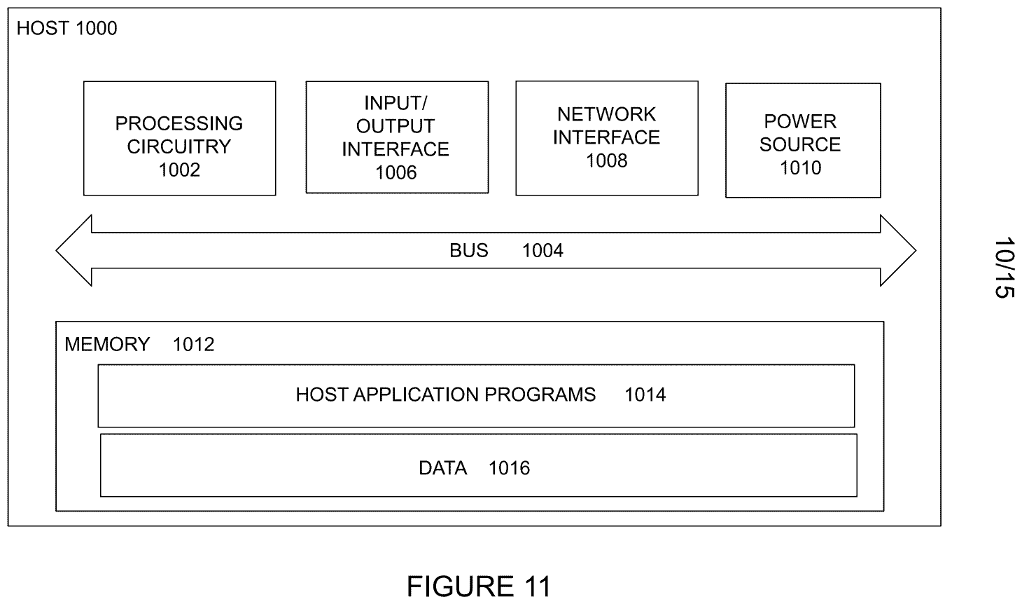

FIG. 11 is a block diagram of a host 1000, which may be an embodiment of the host 716 of FIG. 8, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

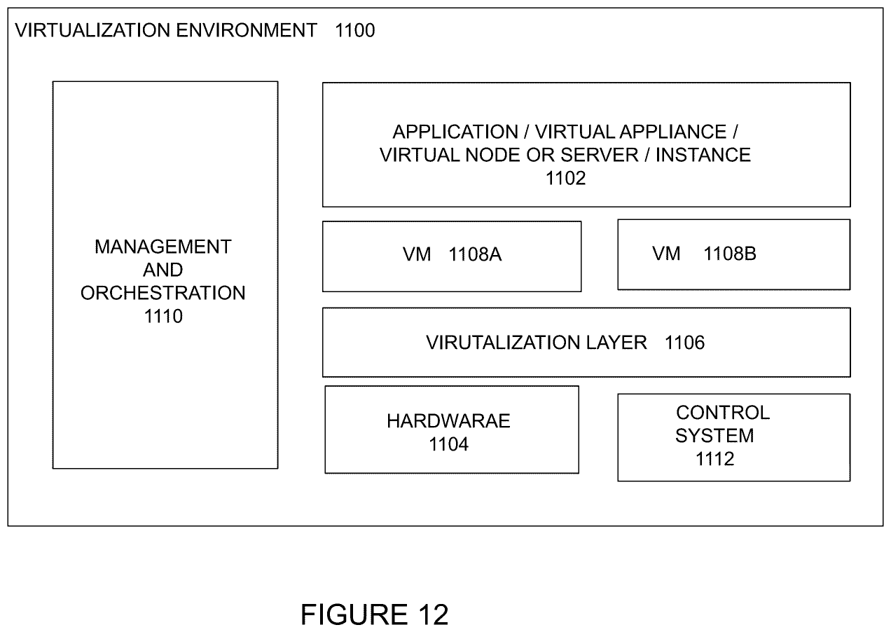

FIG. 12 is a block diagram illustrating a virtualization environment 1100 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

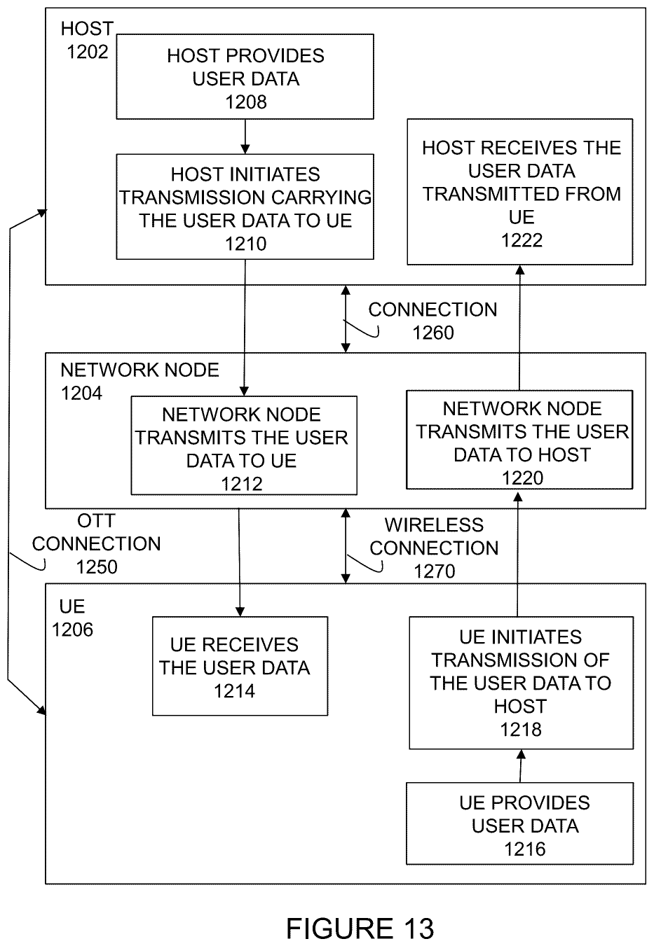

FIG. 13 shows a communication diagram of a host 1202 communicating via a network node 1204 with a UE 1206 over a partially wireless connection in accordance with some embodiments.

Example implementations, in accordance with various embodiments, of the UE (such as a UE 712a of FIG. 8 and/or UE 800 of FIG. 9), network node (such as network node 710a of FIG. 8 and/or network node 900 of FIG. 10), and host (such as host 716 of FIG. 8 and/or host 1000 of FIG. 11) discussed in the preceding paragraphs will now be described with reference to FIG. 13.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 8) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

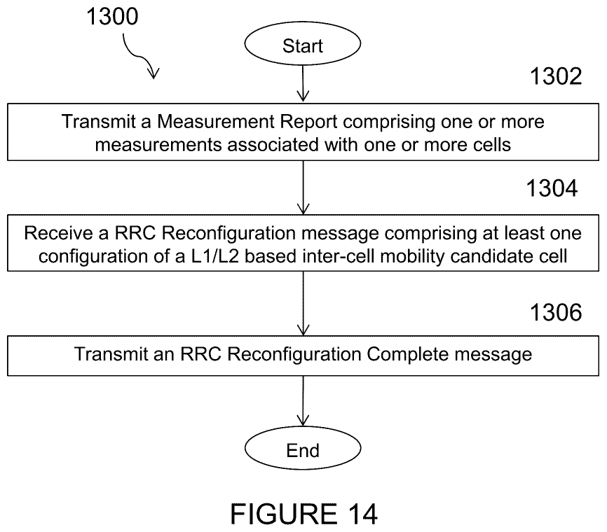

FIG. 14 illustrates a method 1300 by a UE 402, 502, 602, 800 in a connected state for configuring Layer 1/Layer 2, L1/L2, based inter-cell mobility, according to certain embodiments. The method includes transmitting, at step 1302, a Measurement Report that includes one or more measurements associated with one or more cells. At step 1304, the UE 402, 502, 602, 800 receives a RRC Reconfiguration message comprising at least one configuration of a L1/L2 based inter-cell mobility candidate cell. At step 1306, the UE 402, 502, 602, 800 transmits an RRC Reconfiguration Complete message.

In a particular embodiment, the RRC Reconfiguration message comprises one or more of: at least one CSI measurement configuration; and a first cell group configuration that is associated to a current PCell of the UE.

In a further particular embodiment, the at least one CSI measurement configuration and/or the first cell group configuration associated to the current PCell and/or the at least one configuration of the L1/L2 based inter-cell mobility candidate cell are generated by a candidate DU (406, 504, 604), encapsulated in the RRC Reconfiguration message by a CU (404, 506, 606), and received by the UE via the candidate DU.

In a particular embodiment, the UE receives a measurement configuration, and the measurement configuration includes a reporting configuration. The reporting configuration includes at least one triggering condition that when fulfilled triggers transmission of the Measurement Report by the UE.

In a particular embodiment, the UE performs the one or more measurements associated with the one or more cells according to the measurement configuration, and the one or more measurements comprise at least one of a CSI measurement, a L1 RSRP measurement, a differential RSRP measurement, a RSRQ measurement, and a SINR measurement.

In a particular embodiment, the UE determines that the at least one condition is fulfilled, and the Measurement Report is transmitted in response to determining that the at least one condition is fulfilled.

In a particular embodiment, the one of more cells associated with the Measurement Report comprises one or more neighboring cells and/or one or more non-serving cells. Additionally or alternatively, the L1/L2 based inter-cell mobility candidate cell is one of the one or more cells associated with the Measurement Report.

In a particular embodiment, the RRC Reconfiguration message comprises a plurality of configurations, and each one of the plurality of configurations is associated with a respective one of a plurality of L1/L2 based inter-cell mobility candidate cells.

In a particular embodiment, the UE receives lower layer signaling comprising an indication of the L1/L2 based inter-cell mobility candidate cell and/or the configuration associated with the L1/L2 based inter-cell mobility candidate cell. The indication triggers activation of the configuration of the L1/L2 based inter-cell mobility candidate cell. Based on the indication, the UE initiates operation in the L1/L2 based inter-cell mobility candidate cell according to the configuration.

In a particular embodiment, the lower layer signaling is received from a Distributed Unit, DU, and/or the lower layer signaling is received by at least one lower layer of a protocol stack of the UE. The at least one lower layer comprising at least one of: a PDCP layer, a RLC layer, a MAC layer, a Phy Layer, and a L1.

In a particular embodiment, the lower layer signaling is received via a MAC-CE or a DCI.

In a particular embodiment, the at least one L1/L2 based inter-cell mobility candidate cell comprises a candidate to be at least one of: a SpCell, a PCell, a SCell, a PSCell Group Cell, a MSG Cell, and/or a SCG Cell.

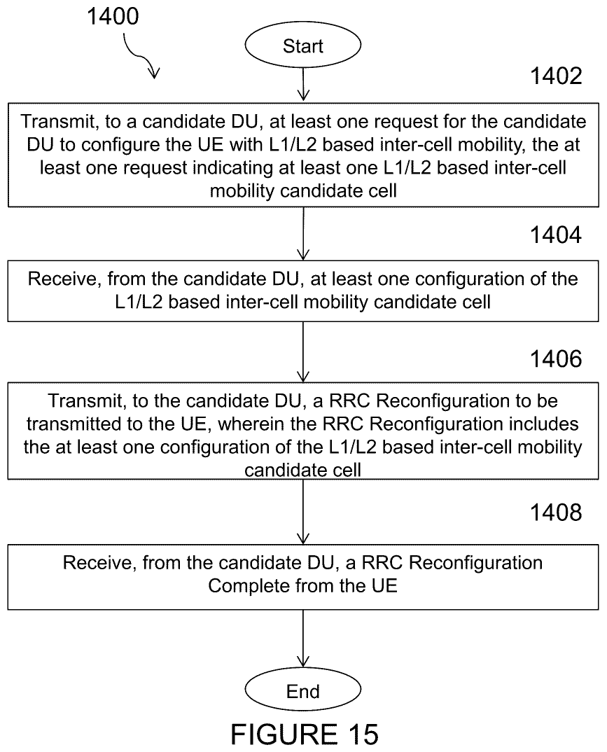

FIG. 15 illustrates a method 1400 by a CU 404, 506, 606, for configuring Layer 1/Layer 2, L1/L2, based inter-cell mobility for a UE 402, 502, 602, 800 in a connected state, according to certain embodiments. The method begins at step 1402 when the CU 404, 506, 606 transmits, to a candidate DU 406, 504, 604, at least one request for the candidate DU to configure the UE with L1/L2 based inter-cell mobility. The at least one request indicates at least one L1/L2 based inter-cell mobility candidate cell. At step 1404, the CU 404, 506, 606 receives, from the candidate DU 406, 504, 604, at least one configuration of the L1/L2 based inter-cell mobility candidate cell. At step 1406, the CU 404, 506, 606 transmits, to the candidate DU 406, 504, 604, a RRC Reconfiguration to be transmitted to the UE. The RRC Reconfiguration includes the at least one configuration of the L1/L2 based inter-cell mobility candidate cell. At step 1408, the CU 404, 506, 606 receives, from the candidate DU 406, 504, 604, an RRC Reconfiguration Complete from the UE 402, 502, 602, 800.

In a particular embodiment, the candidate DU is a source DU with respect to the UE.

In a particular embodiment, the RRC Reconfiguration comprises one or more of: at least one CSI measurement configuration and a first cell group configuration that is associated to a current PCell of the UE.

In a particular embodiment, the CU encapsulates the at least one configuration of the L1/L2 based inter-cell mobility candidate cell in the RRC Reconfiguration message for transmission to the UE via the candidate DU.

In a particular embodiment, the CU receives, from a source DU a Measurement Report of the UE, and the Measurement Report comprises one or more measurements associated with one or more cells.

In a particular embodiment, the one or more measurements comprise one or more values associated with at least one of: a CSI measurement, a L1 RSRP measurement, a differential RSRP measurement, a RSRQ measurement, and a SINR measurement.

In a particular embodiment, the Measurement Report is received in an UL RRC MESSAGE TRANSFER, and the one of more cells associated with the Measurement Report comprises one or more neighboring cells and/or one or more non-serving cells of the UE. Additionally or alternatively, at least one of the L1/L2 based inter-cell mobility candidate cells is one of the one or more cells associated with the Measurement Report.

In a particular embodiment, the request for the candidate DU to configure the UE with the L1/L2 based inter-cell mobility is based on the received Measurement Report that comprises the one or more measurements of the one or more cells.

In a particular embodiment, the CU transmits, to the source DU and before the CU receives the Measurement Report from the source DU, a previous message comprising a measurement configuration. The measurement configuration comprises a reporting configuration, and the reporting configuration comprises at least one triggering condition for triggering transmission of the Measurement Report by the UE when the at least one trigger condition is fulfilled.

In a particular embodiment, at least one of the following holds true:
the at least one request for the candidate DU to configure the UE with L1/L2 based inter-cell mobility is transmitted in at least one UE CONTEXT MODIFICATION REQUEST,
the at least one configuration of the L1/L2 based inter-cell mobility candidate cell is received in a UE CONTEXT MODIFICATION RESPONSE,
the RRC Reconfiguration is transmitted in a UE CONTEXT MODIFICATION REQUEST or a DL RRC MESSAGE TRANSFER, and
the RRC Reconfiguration Complete is received in a UE CONTEXT MODIFICATION RESPONSE or an UL RRC MESSAGE TRANSFER.

In a particular embodiment, at least one message is transmitted and/or received over an F1AP interface between the CU and the candidate DU.

In a particular embodiment, the CU obtains information indicating that the UE is capable of L1/L2 based inter-cell mobility.

In a particular embodiment, the RRC Reconfiguration message comprises a plurality of configurations, and each one of the plurality of configurations being associated with a respective one of a plurality of L1/L2 based inter-cell mobility candidate cells.

In a particular embodiment, the at least one L1/L2 based inter-cell mobility candidate cell comprises a candidate to be at least one of: a SpCell, a PCell, a SCell, a PSCell Group Cell, a MSG Cell, and a SCG Cell.

In a particular embodiment, transmitting the at least one request for the candidate DU to configure the UE with L1/L2 based inter-cell mobility includes transmitting a single message indicating a request for the candidate DU to configure the UE with one L1/L2 based inter-cell mobility candidate cell. The at least one configuration of the L1/L2 based inter-cell mobility candidate cell comprises one configuration of the L1/L2 based inter-cell mobility candidate cell.

In a particular embodiment, transmitting the at least one request for the candidate DU to configure the UE with L1/L2 based inter-cell mobility includes transmitting a plurality of messages to the candidate DU, and each of one of the plurality of messages indicates a request for the candidate DU to configure the UE with a respective one of a plurality of L1/L2 based inter-cell mobility candidate cells. The at least one configuration of the L1/L2 based inter-cell mobility candidate cell comprises one configuration of the L1/L2 based inter-cell mobility candidate cell.

In a particular embodiment, transmitting the at least one request for the candidate DU to configure the UE with L1/L2 based inter-cell mobility includes transmitting a single message to the candidate DU, and the single messages indicates a request for the candidate DU to configure the UE with a plurality of L1/L2 based inter-cell mobility candidate cells. The at least one configuration of the L1/L2 based inter-cell mobility candidate cell comprises a plurality of configurations, and each of the plurality of configurations is associated with a respective one of a plurality of L1/L2 based inter-cell mobility candidate cells.

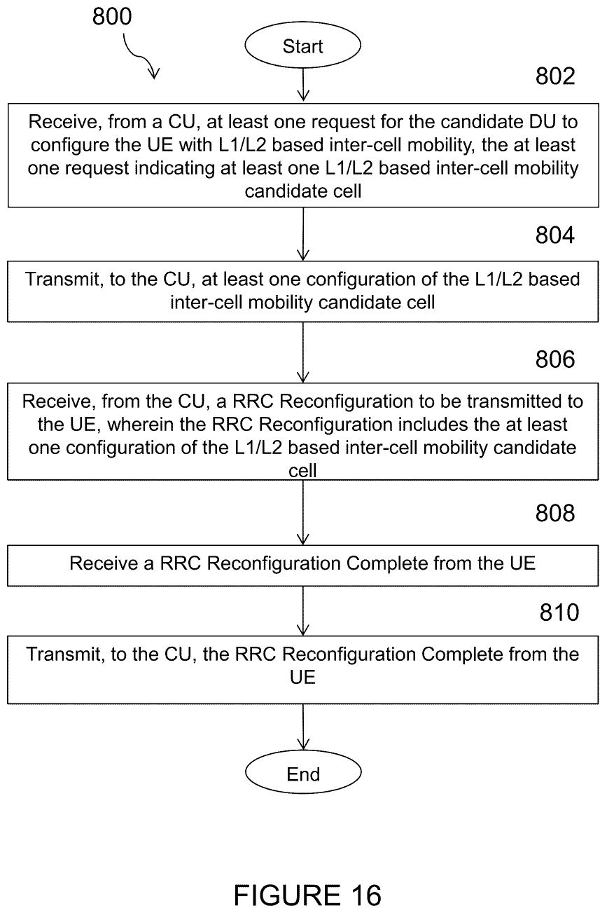

FIG. 16 illustrates a method 1500 by a candidate DU 406, 504, 604, for configuring Layer 1/Layer 2, L1/L2, based inter-cell mobility for a UE 402, 502, 602, 800, in a connected state, according to certain embodiments. The method begins at step 1502 when the candidate DU 406, 504, 604 receives, from a CU 404, 506, 606, at least one request for the candidate DU to configure the UE with L1/L2 based inter-cell mobility. The at least one request indicates at least one L1/L2 based inter-cell mobility candidate cell. At step 1504, the candidate DU 406, 504, 604 transmits, to the CU 404, 506, 606, at least one configuration of the L1/L2 based inter-cell mobility candidate cell. At step 1506, the candidate DU 406, 504, 604 receives, from the CU 404, 506, 606, a RRC Reconfiguration. The RRC Reconfiguration comprises the at least one configuration of the L1/L2 based inter-cell mobility candidate cell. At step 1508, the candidate DU 406, 504, 604 receives an RRC Reconfiguration Complete from the UE 402, 502, 602, 800. At step 1510, the candidate DU 406, 504, 604 transmits, to the CU 404, 506, 606, the RRC Reconfiguration Complete from the UE 402, 502, 602, 800.

In a particular embodiment, the RRC Reconfiguration comprises one or more of: at least one CSI measurement configuration; and a first cell group configuration that is associated to a current Primary Cell of the UE.

In a particular embodiment, the candidate DU is also a source DU with respect to the UE, and the candidate DU transmits, to the CU, a Measurement Report comprising one or more measurements of one or more cells. The candidate DU also transmits, to the UE, the RRC Reconfiguration comprising the at least one configuration of the L1/L2 based inter-cell mobility candidate cell.

In a particular embodiment, prior to transmitting the Measurement Report to the CU, the candidate DU receives the Measurement Report from the UE and encapsulates the Measurement Report in a message for transmission to the CU.

In a particular embodiment, the candidate DU determines at least one L1/L2 inter-cell mobility candidate cell to configured the UE with based on the one or more measurements of the one or more cells and/or the Measurement Report.

In a particular embodiment, the one or more measurements comprise one or more values associated with at least one of: a CSI measurement, a L1 RSRP measurement, a differential RSRP measurement, a RSRQ measurement, and a SINR measurement.

In a particular embodiment, the one of more cells associated with the Measurement Report comprises one or more neighboring cells and/or one or more non-serving cells of the UE.

In a particular embodiment, the Measurement Report is transmitted to the CU in an UL RRC MESSAGE TRANSFER, and/or at least one of the L1/L2 based inter-cell mobility candidate cells is one of the one or more cells associated with the Measurement Report.

In a particular embodiment, at least one of the following is true:
the at least one request for the candidate DU to configure the UE with L1/L2 based inter-cell mobility is received in at least one UE CONTEXT MODIFICATION REQUEST,
the at least one configuration of the L1/L2 based inter-cell mobility candidate cell is transmitted in a UE CONTEXT MODIFICATION RESPONSE,
the RRC Reconfiguration is received in a UE CONTEXT MODIFICATION REQUEST or a DL RRC MESSAGE TRANSFER, and
the RRC Reconfiguration Complete is transmitted in a UE CONTEXT MODIFICATION RESPONSE or an UL RRC MESSAGE TRANSFER.

In a particular embodiment, at least one message is transmitted and/or received over an F1AP interface between the CU and the candidate DU.

In a particular embodiment, the candidate DU obtains information indicating that the UE is capable of L1/L2 based inter-cell mobility.

In a particular embodiment, the RRC Reconfiguration message comprises a plurality of configurations, and each one of the plurality of configurations being associated with a respective one of a plurality of L1/L2 based inter-cell mobility candidate cells.

In a particular embodiment, the at least one L1/L2 based inter-cell mobility candidate cell comprises a candidate to be at least one of: a SpCell, a PCell, a SCell, a PSCell Group Cell, a MCG Cell, and/or a SCG Cell.

In a particular embodiment, the at least one request for the candidate DU to configure the UE with L1/L2 based inter-cell mobility includes receiving a single message indicating a request for the candidate DU to configure the UE with one L1/L2 based inter-cell mobility candidate cell. The at least one configuration of the L1/L2 based inter-cell mobility candidate cell comprises one configuration of the L1/L2 based inter-cell mobility candidate cell.

In a particular embodiment, receiving the at least one request for the candidate DU to configure the UE with L1/L2 based inter-cell mobility includes receiving a plurality of second messages from the CU. Each of one of the plurality of second messages indicates a request for the candidate DU to configure the UE with a respective one of a plurality of L1/L2 based inter-cell mobility candidate cells. The at least one configuration of the L1/L2 based inter-cell mobility candidate cell comprises one configuration of the L1/L2 based inter-cell mobility candidate cell.

In a particular embodiment, receiving at least one request for the candidate DU to configure the UE with L1/L2 based inter-cell mobility includes receiving one second message from the CU, and the second messages indicates a request for the candidate DU to configure the UE with a plurality of L1/L2 based inter-cell mobility candidate cells. The at least one configuration of the L1/L2 based inter-cell mobility candidate cell comprises a plurality of configurations, and wherein each of the plurality of configurations is associated with a respective one of a plurality of L1/L2 based inter-cell mobility candidate cells.

In a particular embodiment, the candidate DU transmits, to the UE, lower layer signaling comprising an indication of the L1/L2 based inter-cell mobility candidate cell and/or the configuration associated with the L1/L2 based inter-cell mobility candidate cell to trigger activation of the configuration of the L1/L2 based inter-cell mobility candidate cell, and wherein the lower layer signaling is transmitted to and/or received by at least one lower layer of a protocol stack of the UE. The at least one lower layer comprises at least one of: a PDCP layer, a RLC layer, a MAC layer, a Physical Layer, and L1.

In a particular embodiment, the lower layer signaling is transmitted via a MAC-CE or a DCI.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for configuring L1/L2 based inter-cell mobility, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for configuring L1/L2 based inter-cell mobility, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) in a connected state for configuring L1/L2 based inter-cell mobility, the method comprising: receiving a first message comprising a measurement configuration, wherein the measurement configuration comprises a reporting configuration, wherein the reporting configuration comprises at least one triggering condition that when fulfilled triggers transmission of a Measurement Report by the UE; transmitting the Measurement Report comprising one or more measurements associated with one or more cells; receiving an RRC Reconfiguration message comprising at least one configuration of a L1/L2 based inter-cell mobility candidate cell; and transmitting an RRC Reconfiguration Complete message.

Example Embodiment C2. The method of Example Embodiment C1, wherein the RRC Reconfiguration message comprises one or more of: at least one CSI measurement configuration; and a first cell group configuration that is associated to a current Primary Cell (PCell) of the UE.

Example Embodiment C3. The method of any one of Example Embodiments C1 to C2, wherein the at least one CSI measurement configuration and/or the first cell group configuration associated to the current PCell and/or the at least one configuration of the L1/L2 based inter-cell mobility candidate cell are generated by a Distributed Unit (DU), encapsulated in the RRC Reconfiguration message by a Central Unit (CU), and received by the UE via the DU.

Example Embodiment C4. The method of any one of Example Embodiments C1 to C3, further comprising: performing the one or more measurements associated with the one or more cells according to the measurement configuration.

Example Embodiment C5. The method of any one of Example Embodiments C1 to C4, wherein the measurement configuration comprises a Channel State Information (CSI) measurement configuration.

Example Embodiment C6. The method of any one of Example Embodiments C1 to C5, wherein the one or more measurements comprise at least one of a L1 RSRP measurement, a differential RSRP measurement, a RSRQ measurement, and/or a SINR measurement.

Example Embodiment C7. The method of any one of Example Embodiments C1 to C6, wherein the one of more cells associated with the Measurement Report comprises one or more neighboring cells and/or one or more non-serving cells.

Example Embodiment C8. The method of any one of Example Embodiments C1 to C7, wherein the L1/L2 based inter-cell mobility candidate cell is one of the one or more cells associated with the Measurement Report.

Example Embodiment C9. The method of any one of Example Embodiments C1 to C8, further comprising: determining that the at least one condition is fulfilled, and wherein the Measurement Report is transmitted in response to determining that the at least one condition is fulfilled.

Example Embodiment C10. The method of any one of Example Embodiments C1 to C9, wherein the RRC Reconfiguration message comprises a plurality of configurations, each one of the plurality of configurations being associated with a respective one of a plurality of L1/L2 based inter-cell mobility candidate cells.

Example Embodiment C11. The method of any one of Example Embodiments C1 to C10, further comprising: receiving lower layer signaling comprising an indication of the L1/L2 based inter-cell mobility candidate cell and/or the configuration associated with the L1/L2 based inter-cell mobility candidate cell, based on the indication, initiating operation in the L1/L2 based inter-cell mobility candidate cell according to the configuration.

Example Embodiment C12. The method of Example Embodiment C11, wherein the lower layer signaling comprising the indication triggers activation of the configuration of the L1/L2 based inter-cell mobility candidate cell.

Example Embodiment C13. The method of any one of Example Embodiments C11 to C12, wherein the lower layer signaling is received from the Distributed Unit (DU).

Example Embodiment C14. The method of any one of Example Embodiments C11 to C13, wherein the lower layer signaling is received by at least one lower layer of a protocol stack of the UE, the at least one lower layer comprising at least one of: PDCP, RLC, MAC, PHY, or Layer 1.

Example Embodiment C15. The method of any one of Example Embodiments C11 to C14, wherein the lower layer signaling is received via a MAC Control Element or a Downlink Control Information (DCI).

Example Embodiment C16. The method of any one of Example Embodiments C1 to C15, wherein the at least one L1/L2 based inter-cell mobility candidate cell comprises a candidate to be at least one of: a Special cell (SpCell), a Primary Cell (PCell), a Secondary Cell (SCell), a Primary Secondary Cell Group (SCG) Cell (PSCell), a Master Cell Group (MCG) cell, and/or a SCG cell.

Example Embodiment C17. The method of Example Embodiments C1 to C16, further comprising: providing user data; and forwarding the user data to a host via the transmission to the network node.

Example Embodiment C18. A user equipment comprising processing circuitry configured to perform any of the methods of Example Embodiments C1 to C17.

Example Embodiment C19. A wireless device comprising processing circuitry configured to perform any of the methods of Example Embodiments C1 to C17.

Example Embodiment C20. A computer program comprising instructions which when executed on a computer perform any of the methods of Example Embodiments C1 to C17.

Example Embodiment C21. A computer program product comprising computer program, the computer program comprising instructions which when executed on a computer perform any of the methods of Example Embodiments C1 to C17.

Example Embodiment C22. A non-transitory computer readable medium storing instructions which when executed by a computer perform any of the methods of Example Embodiments C1 to C17.

### Group D Example Embodiments

Example Embodiment D1. A method by a Central Unit for configuring L1/L2 based inter-cell mobility for a user equipment (UE) in a connected state, the method comprising: receiving, from a Distributed Unit (DU), a first message comprising a Measurement Report of the UE, wherein the Measurement Report comprises one or more measurements associated with one or more cells; transmitting, to the DU, at least one second message indicating a request for the DU to configure the UE with L1/L2 based inter-cell mobility; receiving, from the DU, a third message comprising at least one configuration of a L1/L2 based inter-cell mobility candidate cell; transmitting, to the DU, a fourth message comprising an RRC Reconfiguration to be transmitted to the UE, wherein the RRC Reconfiguration includes the at least one configuration of the L1/L2 based inter-cell mobility candidate cell; and receiving, from the DU, a fifth message comprising an RRC Reconfiguration Complete from the UE.

Example Embodiment D2. The method of Example Embodiment D1, wherein the RRC Reconfiguration message comprises one or more of: at least one CSI measurement configuration; and a first cell group configuration that is associated to a current Primary Cell (PCell) of the UE.

Example Embodiment D3. The method of any one of Example Embodiments D1 to D2, further comprising: encapsulating the at least one configuration of the L1/L2 based inter-cell mobility candidate cell in the RRC Reconfiguration message for transmission to the UE via the DU.

Example Embodiment D4. The method of any one of Example Embodiments D1 to D3, wherein the one or more measurements comprise one or more Channel State Information (CSI) measurements.

Example Embodiment D5. The method of any one of Example Embodiments D1 to D4, wherein the one or more measurements comprise one or more values associated with at least one of: a L1 RSRP measurement, a differential RSRP measurement, a RSRQ measurement, and/or a SINR measurement.

Example Embodiment D6. The method of any one of Example Embodiments D1 to D5, wherein the one of more cells associated with the Measurement Report comprises one or more neighboring cells and/or one or more non-serving cells of the UE.

Example Embodiment D7. The method of any one of Example Embodiments D1 to D6, wherein at least one of the L1/L2 based inter-cell mobility candidate cells is one of the one or more cells associated with the Measurement Report.

Example Embodiment D8a. The method of any one of Example Embodiments D1 to D7, wherein the first message comprises an UL RRC MESSAGE TRANSFER.

Example Embodiment D8b. The method of any one of Example Embodiments D1 to D8a, wherein the at least one second message comprises at least one UE CONTEXT MODIFICATION REQUEST.

Example Embodiment D9. The method of any one of Example Embodiments D1 to D8b, wherein the third message comprises a UE CONTEXT MODIFICATION RESPONSE.

Example Embodiment D10. The method of any one of Example Embodiments D1 to D9, wherein the fourth message comprises a UE CONTEXT MODIFICATION REQUEST or a DL RRC MESSAGE TRANSFER.

Example Embodiment D11. The method of any one of Example Embodiments D1 to D10, wherein the fifth message comprises a UE CONTEXT MODIFICATION RESPONSE or an UL RRC MESSAGE TRANSFER.

Example Embodiment D12. The method of any one of Example Embodiments D1 to D11, wherein at least one of the first message, the at least one second message, the third message, the fourth message, and/or the fifth message are transmitted and/or received over an FIAP interface between the CU and the DU.

Example Embodiment D13. The method of any one of Example Embodiments D1 to D12, wherein the at least one second message indicating the request for the DU to configure the UE with the L1/L2 based inter-cell mobility is based on the received Measurement Report that comprises the one or more measurements of the one or more cells.

Example Embodiment D14. The method of any one of Example Embodiments D1 to D13, wherein the first message comprises the one or more measurements of the one or more cells and/or the Measurement Report.

Example Embodiment D15. The method of any one of Example Embodiments D1 to D14, further comprising: transmitting, to the DU and before the CU receives the first message comprising the Measurement Report from the DU, a previous message comprising a measurement configuration, wherein the measurement configuration comprises a reporting configuration, and the reporting configuration comprises at least one triggering condition for triggering transmission of the Measurement Report by the UE when the at least one trigger condition is fulfilled.

Example Embodiment D16. The method of any one of Example Embodiments D1 to D15, further comprising obtaining information indicating that the UE is capable of L1/L2 based inter-cell mobility.

Example Embodiment D17. The method of any one of Example Embodiments D1 to D16, wherein the RRC Reconfiguration message comprises a plurality of configurations, each one of the plurality of configurations being associated with a respective one of a plurality of L1/L2 based inter-cell mobility candidate cells.

Example Embodiment D18. The method of any one of Example Embodiments D1 to D17, wherein the at least one L1/L2 based inter-cell mobility candidate cell comprises a candidate to be at least one of: a Special cell (SpCell), a Primary Cell (PCell), a Secondary Cell (SCell), a Primary Secondary Cell Group (SCG) Cell (PSCell), a Master Cell Group (MCG) cell, and/or a SCG cell.

Example Embodiment D19. The method of any one of Example Embodiments D1 to D18, wherein transmitting the at least one second message to the DU comprises: transmitting one second message indicating a request for the DU to configure the UE with one L1/L2 based inter-cell mobility candidate cell, and the third message comprises one configuration of the L1/L2 based inter-cell mobility candidate cell.

Example Embodiment D20. The method of any one of Example Embodiments D1 to D18, wherein transmitting the at least one second message to the DU comprises: transmitting a plurality of second messages to the DU, wherein each of one of the plurality of second messages indicates a request for the DU to configure the UE with a respective one of a plurality of L1/L2 based inter-cell mobility candidate cells, and wherein the third message comprises one configuration of the L1/L2 based inter-cell mobility candidate cell.

Example Embodiment D21. The method of any one of Example Embodiments D1 to D18, wherein transmitting the at least one second message to the DU comprises: transmitting one second message to the DU, wherein the second messages indicates a request for the DU to configure the UE with a plurality of L1/L2 based inter-cell mobility candidate cells, and wherein the third message comprises a plurality of configurations, and wherein each of the plurality of configurations is associated with a respective one of a plurality of L1/L2 based inter-cell mobility candidate cells.

Example Embodiment D22. The method of any one of Example Embodiments D1 to D21, wherein the network node comprises a gNodeB (gNB).

Example Embodiment D23. The method of any of Example Embodiments D1 to D22, further comprising: obtaining user data; and forwarding the user data to a host or a user equipment.

Example Embodiment D24. A network node comprising processing circuitry configured to perform any of the methods of Example Embodiments D1 to D23.

Example Embodiment D25. A computer program comprising instructions which when executed on a computer perform any of the methods of Example Embodiments D1 to D23.

Example Embodiment D26. A computer program product comprising computer program, the computer program comprising instructions which when executed on a computer perform any of the methods of Example Embodiments D1 to D23.

Example Embodiment D27. A non-transitory computer readable medium storing instructions which when executed by a computer perform any of the methods of Example Embodiments D1 to D23.

### Group E Example Embodiments

Example Embodiment E1. A method by a Distributed Unit for configuring L1/L2 based inter-cell mobility for a user equipment (UE) in a connected state, the method comprising: transmitting, to a Central Unit (CU), a first message comprising a Measurement Report, wherein the Measurement Report comprises one or more measurements of one or more cells; receiving, from the CU, at least one second message indicating a request for the DU to configure the UE with L1/L2 based inter-cell mobility; transmitting, to the CU, a third message comprising at least one configuration of a L1/L2 based inter-cell mobility candidate cell; receiving, from the CU, a fourth message comprising an RRC Reconfiguration, wherein the RRC Reconfiguration comprises the at least one configuration of the L1/L2 based inter-cell mobility candidate cell; transmitting, to the UE, the RRC Reconfiguration comprising the at least one configuration of the L1/L2 based inter-cell mobility candidate cell; receiving an RRC Reconfiguration Complete from the UE; and transmitting, to the CU, a fifth message comprising the RRC Reconfiguration Complete from the UE.

Example Embodiment E2. The method of Example Embodiment E1, wherein the RRC Reconfiguration message comprises one or more of: at least one CSI measurement configuration; and a first cell group configuration that is associated to a current Primary Cell (PCell) of the UE.

Example Embodiment E3. The method of any one of Example Embodiments E1 to E2, wherein prior to transmitting the first message, the method further comprises: receiving the Measurement Report from the UE; and encapsulating the Measurement Report in the first message for transmission to the CU.

Example Embodiment E4. The method of any one of Example Embodiments E1 to E3, wherein the one or more measurements comprise one or more Channel State Information (CSI) measurements.

Example Embodiment E5. The method of any one of Example Embodiments E1 to E4, wherein the one or more measurements comprise one or more values associated with at least one of: a L1 RSRP measurement, a differential RSRP measurement, a RSRQ measurement, and/or a SINR measurement.

Example Embodiment E6. The method of any one of Example Embodiments E1 to E5, wherein the one of more cells associated with the Measurement Report comprises one or more neighboring cells and/or one or more non-serving cells of the UE.

Example Embodiment E7. The method of any one of Example Embodiments E1 to E6, wherein at least one of the L1/L2 based inter-cell mobility candidate cells is one of the one or more cells associated with the Measurement Report.

Example Embodiment E8a. The method of any one of Example Embodiments E1 to E7, wherein the first message comprises an UL RRC MESSAGE TRANSFER.

Example Embodiment E8b. The method of any one of Example Embodiments E1 to E8a, wherein the at least one second message comprises at least one UE CONTEXT MODIFICATION REQUEST.

Example Embodiment E9. The method of any one of Example Embodiments E1 to E8b, wherein the third message comprises a UE CONTEXT MODIFICATION RESPONSE.

Example Embodiment E10. The method of any one of Example Embodiments E1 to E9, wherein the fourth message comprises a UE CONTEXT MODIFICATION REQUEST or a DL RRC MESSAGE TRANSFER.

Example Embodiment E11. The method of any one of Example Embodiments E1 to E10, wherein the fifth message comprises a UE CONTEXT MODIFICATION RESPONSE or an UL RRC MESSAGE TRANSFER.

Example Embodiment E12. The method of any one of Example Embodiments E1 to Ell, wherein at least one of the first message, the at least one second message, the third message, the fourth message, and/or the fifth message are transmitted and/or received over an FIAP interface between the CU and the DU.

Example Embodiment E13. The method of any one of Example Embodiments E1 to E12, wherein the at least one second message indicating the request for the DU to configure the UE with the L1/L2 based inter-cell mobility is based on the received Measurement Report that comprises the one or more measurements of the one or more cells.

Example Embodiment E14a. The method of any one of Example Embodiments E1 to E13, wherein the first message comprises the one or more measurements of the one or more cells and/or the Measurement Report.

Example Embodiment E14b. The method of any one of Example Embodiments E1 to E14a, further comprising determining at least one L1/L2 inter-cell mobility candidate cell to configured the UE with based on the one or more measurements of the one or more cells and/or the Measurement Report.

Example Embodiment E15a. The method of any one of Example Embodiments E1 to E14b, wherein before the Measurement Report is received, the method further comprises: transmitting, to the UE, a previous message comprising a measurement configuration, wherein the measurement configuration comprises a reporting configuration, and wherein the reporting configuration comprises at least one triggering condition for triggering transmission of the Measurement Report by the UE when the at least one trigger condition is fulfilled.

Example Embodiment E15b. The method of Example Embodiment E15a, further comprising receiving the measurement configuration from the CU.

Example Embodiment E16. The method of any one of Example Embodiments E1 to E15b, further comprising obtaining information indicating that the UE is capable of L1/L2 based inter-cell mobility.

Example Embodiment E17. The method of any one of Example Embodiments E1 to E16, wherein the RRC Reconfiguration message comprises a plurality of configurations, each one of the plurality of configurations being associated with a respective one of a plurality of L1/L2 based inter-cell mobility candidate cells.

Example Embodiment E18. The method of any one of Example Embodiments E1 to E17, wherein the at least one L1/L2 based inter-cell mobility candidate cell comprises a candidate to be at least one of: a Special cell (SpCell), a Primary Cell (PCell), a Secondary Cell (SCell), a Primary Secondary Cell Group (SCG) Cell (PSCell), a Master Cell Group (MCG) cell, and/or a SCG cell.

Example Embodiment E19. The method of any one of Example Embodiments E1 to E18, wherein receiving the at least one second message from the CU comprises: receiving one second message indicating a request for the DU to configure the UE with one L1/L2 based inter-cell mobility candidate cell, and wherein the third message comprises one configuration of the L1/L2 based inter-cell mobility candidate cell.

Example Embodiment E20. The method of any one of Example Embodiments E1 to E18, wherein receiving the at least one second message from the CU comprises: receiving a plurality of second messages from the CU, wherein each of one of the plurality of second messages indicates a request for the DU to configure the UE with a respective one of a plurality of L1/L2 based inter-cell mobility candidate cells, and wherein the third message comprises one configuration of the L1/L2 based inter-cell mobility candidate cell.

Example Embodiment E21. The method of any one of Example Embodiments E1 to E18, wherein receiving the at least one second message from the CU comprises: receiving one second message from the CU, wherein the second messages indicates a request for the DU to configure the UE with a plurality of L1/L2 based inter-cell mobility candidate cells, and wherein the third message comprises a plurality of configurations, and wherein each of the plurality of configurations is associated with a respective one of a plurality of L1/L2 based inter-cell mobility candidate cells.

Example Embodiment E22. The method of any one of Example Embodiments E1 to E21, further comprising: transmitting, to the UE, lower layer signaling comprising an indication of the L1/L2 based inter-cell mobility candidate cell and/or the configuration associated with the L1/L2 based inter-cell mobility candidate cell to trigger activation of the configuration of the L1/L2 based inter-cell mobility candidate cell.

Example Embodiment E23. The method of Example Embodiment E22, wherein the lower layer signaling is transmitted to and/or received by at least one lower layer of a protocol stack of the UE, the at least one lower layer comprising at least one of: PDCP, RLC, MAC, PHY, or Layer 1.

Example Embodiment E24. The method of any one of Example Embodiments E22 to E23, wherein the lower layer signaling is transmitted via a MAC Control Element or a Downlink Control Information (DCI).

Example Embodiment E25. The method of any one of Example Embodiments E1 to E24, wherein the network node comprises a gNodeB (gNB).

Example Embodiment E26. The method of any of Example Embodiments E1 to E25, further comprising: obtaining user data; and forwarding the user data to a host or a user equipment.

Example Embodiment E27. A network node comprising processing circuitry configured to perform any of the methods of Example Embodiments E1 to E26.

Example Embodiment E28. A computer program comprising instructions which when executed on a computer perform any of the methods of Example Embodiments E1 to E26.

Example Embodiment E29. A computer program product comprising computer program, the computer program comprising instructions which when executed on a computer perform any of the methods of Example Embodiments E1 to E26.

Example Embodiment E30. A non-transitory computer readable medium storing instructions which when executed by a computer perform any of the methods of Example Embodiments E1 to E26.

### Group F Example Embodiments

Example Embodiment F1. A user equipment in a connected state for configuring L1/L2 based inter-cell mobility, comprising: processing circuitry configured to perform any of the steps of any of the Group A and C Example Embodiments; and power supply circuitry configured to supply power to the processing circuitry.

Example Embodiment F2. A network node for configuring L1/L2 based inter-cell mobility for a user equipment (UE) in a connected state, the network node comprising: processing circuitry configured to perform any of the steps of any of the Group B, D, and E Example Embodiments; power supply circuitry configured to supply power to the processing circuitry.

Example Embodiment E3. A user equipment (UE) in a connected state for configuring L1/L2 based inter-cell mobility, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, D, and E Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, and E Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, and E Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and E Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, D, and E Example Embodiments to receive the user data from the UE for the host.

Example Embodiment E27. The method of the previous Example Embodiment, further comprising at the network node, transmitting the received user data to the host.

1. A method by a user equipment, UE, in a connected state for configuring Layer 1/Layer 2, L1/L2, based inter-cell mobility, the method comprising:
transmitting a Measurement Report comprising one or more measurements associated with one or more cells;
receiving a Radio Resource Control, RRC, Reconfiguration message comprising at least one configuration of a L1/L2 based inter-cell mobility candidate cell; and
transmitting an RRC Reconfiguration Complete message.

2. The method of claim 1, wherein the RRC Reconfiguration message comprises one or more of:
at least one Channel State Information, CSI, measurement configuration; and
a first cell group configuration that is associated to a current Primary Cell, PCell, of the UE.

3. The method of claim 2, wherein the at least one CSI measurement configuration and/or the first cell group configuration associated to the current PCell and/or the at least one configuration of the L1/L2 based inter-cell mobility candidate cell are generated by a candidate Distributed Unit, DU (406, 504, 604), encapsulated in the RRC Reconfiguration message by a Central Unit, CU (404, 506, 606), and received by the UE via the candidate DU.

4. The method of claim 1, comprising:
receiving a measurement configuration, wherein the measurement configuration comprises a reporting configuration, wherein the reporting configuration comprises at least one triggering condition that when fulfilled triggers transmission of the Measurement Report by the UE.

5. The method of claim 4, comprising:
performing the one or more measurements associated with the one or more cells according to the measurement configuration, and
wherein the one or more measurements comprise at least one of:
a Channel State Information measurement,
a Layer 1 Reference Signal Received Power measurement,
a differential Reference Signal Received Power measurement,
a Reference Signal Received Quality measurement, and
a Signal Interference to Noise Ratio measurement.

6. The method of claim 4 comprising:
determining that the at least one condition is fulfilled, and
wherein the Measurement Report is transmitted in response to determining that the at least one condition is fulfilled.

7. The method of claim 1, wherein at least one of:
the one of more cells associated with the Measurement Report comprises one or more neighboring cells and/or one or more non-serving cells, and
the L1/L2 based inter-cell mobility candidate cell is one of the one or more cells associated with the Measurement Report.

8. The method of claim 1, wherein the RRC Reconfiguration message comprises a plurality of configurations, each one of the plurality of configurations being associated with a respective one of a plurality of L1/L2 based inter-cell mobility candidate cells.

9. The method of claim 1, comprising:
receiving lower layer signaling comprising an indication of the L1/L2 based inter-cell mobility candidate cell and/or the configuration associated with the L1/L2 based inter-cell mobility candidate cell, wherein the indication triggers activation of the configuration of the L1/L2 based inter-cell mobility candidate cell, and
based on the indication, initiating operation in the L1/L2 based inter-cell mobility candidate cell according to the configuration.

10. The method of claim 9, wherein at least one of:
the lower layer signaling is received from a Distributed Unit, DU, and
the lower layer signaling is received by at least one lower layer of a protocol stack of the UE, the at least one lower layer comprising at least one of:
a Packet Data Convergence Protocol layer,
a Radio Link Control layer,
a Medium Access Control layer,
a Physical Layer, and
a Layer 1, L1.

11. The method of claim 9, wherein the lower layer signaling is received via a Medium Access Control-Control Element or a Downlink Control Information.

12. The method of claim 1, wherein the at least one L1/L2 based inter-cell mobility candidate cell comprises a candidate to be at least one of:
a Special Cell,
a Primary Cell,
a Secondary Cell,
a Primary Secondary Cell Group Cell,
a Master Cell Group Cell, and/or
a Secondary Cell Group Cell.

13. A method by a Central Unit, CU for configuring Layer 1/Layer 2, L1/L2, based inter-cell mobility for a user equipment, UE, in a connected state, the method comprising:
transmitting, to a candidate DU, at least one request for the candidate DU to configure the UE with L1/L2 based inter-cell mobility, the at least one request indicating at least one L1/L2 based inter-cell mobility candidate cell;
receiving, from the candidate DU, at least one configuration of the L1/L2 based inter-cell mobility candidate cell;
transmitting, to the candidate DU, a Radio Resource Configuration, RRC, Reconfiguration to be transmitted to the UE, wherein the RRC Reconfiguration includes the at least one configuration of the L1/L2 based inter-cell mobility candidate cell; and
receiving, from the candidate DU, an RRC Reconfiguration Complete from the UE.

14. The method of claim 13, wherein the candidate DU is a source DU with respect to the UE.

15. The method of claim 13, wherein the RRC Reconfiguration comprises one or more of:
at least one Channel State Information, CSI, measurement configuration; and
a first cell group configuration that is associated to a current Primary Cell, PCell, of the UE.

16. The method of claim 13, comprising:
encapsulating the at least one configuration of the L1/L2 based inter-cell mobility candidate cell in the RRC Reconfiguration message for transmission to the UE via the candidate DU.

17. The method of claim 13, comprising receiving, from a source Distributed Unit, DU, a Measurement Report of the UE, wherein the Measurement Report comprises one or more measurements associated with one or more cells.

18. The method of claim 17, wherein the one or more measurements comprise one or more values associated with at least one of:
a Channel State Information measurement,
a Layer 1 Reference Signal Received Power measurement,
a differential Reference Signal Received Power measurement,
a Reference Signal Received Quality measurement, and
a Signal to Interference Noise Ratio measurement.

19. The method of claim 13, wherein at least one of:
the Measurement Report is received in an UL RRC MESSAGE TRANSFER,
the one of more cells associated with the Measurement Report comprises one or more neighboring cells and/or one or more non-serving cells of the UE, and
at least one of the L1/L2 based inter-cell mobility candidate cells is one of the one or more cells associated with the Measurement Report.

20. The method of claim 17, wherein the request for the candidate DU to configure the UE with the L1/L2 based inter-cell mobility is based on the received Measurement Report that comprises the one or more measurements of the one or more cells.

21. The method of claim 17, comprising:
transmitting, to the source DU and before the CU receives the Measurement Report from the source DU, a previous message comprising a measurement configuration,
wherein the measurement configuration comprises a reporting configuration, and
the reporting configuration comprises at least one triggering condition for triggering transmission of the Measurement Report by the UE when the at least one trigger condition is fulfilled.

22. The method of claim 13, wherein at least one of:
the at least one request for the candidate DU to configure the UE with L1/L2 based inter-cell mobility is transmitted in at least one UE CONTEXT MODIFICATION REQUEST,
the at least one configuration of the L1/L2 based inter-cell mobility candidate cell is received in a UE CONTEXT MODIFICATION RESPONSE,
the RRC Reconfiguration is transmitted in a UE CONTEXT MODIFICATION REQUEST or a DL RRC MESSAGE TRANSFER, and
the RRC Reconfiguration Complete is received in a UE CONTEXT MODIFICATION RESPONSE or an UL RRC MESSAGE TRANSFER.

23. The method of claim 13, wherein at least one message is transmitted and/or received over an F1 Application Protocol, F1AP, interface between the CU and the candidate DU.

24. The method of claim 13, comprising obtaining information indicating that the UE is capable of L1/L2 based inter-cell mobility.

25.-29. (canceled)

30. A method by a candidate Distributed Unit, DU, for configuring Layer 1/Layer 2, L1/L2, based inter-cell mobility for a user equipment, UE, in a connected state, the method comprising:
receiving, from a Central Unit, CU, at least one request for the candidate DU to configure the UE with L1/L2 based inter-cell mobility, the at least one request indicating at least one L1/L2 based inter-cell mobility candidate cell;
transmitting, to the CU, at least one configuration of the L1/L2 based inter-cell mobility candidate cell;
receiving, from the CU, a Radio Resource Control, RRC, Reconfiguration, wherein the RRC Reconfiguration comprises the at least one configuration of the L1/L2 based inter-cell mobility candidate cell;
receiving an RRC Reconfiguration Complete from the UE; and
transmitting, to the CU, the RRC Reconfiguration Complete from the UE.

31.-47. (canceled)

48. A user equipment, UE, in a connected state for configuring Layer 1/Layer 2, L1/L2, based inter-cell mobility, the UE adapted to:
transmit a Measurement Report comprising one or more measurements associated with one or more cells;
receive a Radio Resource Control, RRC, Reconfiguration message comprising at least one configuration of a L1/L2 based inter-cell mobility candidate cell; and
transmit an RRC Reconfiguration Complete message.

49.-53. (canceled)
